(19) United States
(12) Patent Application Publication
(10) Pub. No.: US 2021/0162724 A1
(43) Pub. Date: Jun. 3, 2021

(54) COATING AGENT COMPOSITION AND LAMINATED FILM

(71) Applicant: NATOCO Co., Ltd., Miyoshi-shi (JP)

(72) Inventor: Susumu ONO, Nagoya-shi (JP)

(21) Appl. No.: 17/103,655

(22) Filed: Nov. 24, 2020

(30) Foreign Application Priority Data
Nov. 28, 2019 (JP) 2019-215307

(51) Int. Cl. B32B 27/08; B32B 33/00; B32B 27/26; B32B 27/30; B32B 27/40; B32B 7/12; C08F 220/18; C08F 220/20; C08F 224/00; C08G 18/73; C08G 18/76; C08G 18/44; C08G 18/48

(52) U.S. Cl. CPC B32B 27/08; B32B 2605/00; B32B 27/26; B32B 27/30; B32B 27/40; B32B 7/12; C08F 220/1806; C08F 220/1811; C08F 220/20; C08F 224/00; C08G 18/73; C08G 18/7621; C08G 18/44; C08G 18/48; B32B 2255/10; B32B 2307/584; B32B 2307/7246; B32B 2307/712; B32B 2375/00; C08G 2150/00; B32B 33/00

(57) ABSTRACT

It is an object of the present invention to provide a coating agent composition from which a cured layer superior in water scale resistance and chemical resistance as well as in processability can be obtained. A cured film superior in water scale resistance and chemical resistance as well as in processability can be obtained from a coating agent composition for a laminated film to protect an exterior curved surface of a vehicle, including a component (A1): a (meth)acrylic resin having a hydroxyl group, and a component (B): a polyfunctional isocyanate compound, wherein the component (A1) has an alicyclic structure (a11) and a structure (a12) selected from the group consisting of polylactone, polycarbonate, polyester and polyether, and the component (A1) has a hydroxyl value of 50 to 150 mg KOH/g.

### FIELD OF INVENTION

The present invention relates to a coating agent composition for a laminated film, and a laminated film. More specifically, the present invention relates to a coating agent composition for use for a laminated film being superior in processability as well as water scale resistance and chemical resistance of a cured film and being to protect an exterior curved surface of a vehicle, and to a laminated film prepared using the composition which is to protect an exterior curved surface of a vehicle.

### BACKGROUND

For the protection of coated surfaces of vehicle bodies such as an automobiles, laminated films called paint protection films (PPF) which are to be attached to the coated surfaces have been supplied to the market. PPF has a basic structure including at least a flexible substrate layer and an adhesive layer, and usually, a functional coating layer having such characteristics as antifouling property, chemical resistance, scratch resistance, and/or self-healing property is further laminated on the side opposite from the adhesive layer. With the expansion of the PPF market in recent years, various studies have been conducted with the aim of further improving the performance of the functional coating layer.

For example, in JP-A-2015-98574, an adhesive sheet which includes at least a substrate and an adhesive layer, wherein the substrate has a substrate layer, a load at the time of 5% elongation of the substrate is 15 N/cm or less, a stress relaxation rate of the substrate by elongating to 10%, stopping the elongation at that state and after lapsing 600 seconds is 40% or more and 100% or less, and a chemical weight increased ratio of the substrate is 60% or less is described to have good curved surface followability and superior chemical resistance. Concrete evaluation of the chemical resistance is performed on the basis of a weight increased ratio before and after immersing a sample for measurement in a solvent in which regular gasoline and ethanol has been mixed with a ratio of 90% by weight/10% by weight.

In JP-A-2015-52100, an adhesive sheet including at least a substrate and an adhesive layer, a static friction coefficient of the substrate being 0.05 or more and 1.50 or less, and an absolute value of a ΔL* value of the substrate being 0.01 or more and 45.00 or less is described to have a surface sliding property and be superior in stain resistance. As to concrete evaluation of stain resistance, contaminated water (JIS Z-8901-84 8 kinds of dust/water/carbon black/yellow ocher were mixed with a mass ratio of 1.3/98/0.5/0.2) is applied to an adhesive sheet adhered to an acrylic baked white panel, then dried at 50° C. for 10 minutes, and this procedure is carried out for 8 cycles, and then the evaluation is made on the basis of a change in L* value from the initial value.

In WO 2016/159023, a surface layer formed from a coating agent, including urethane (meth)acrylate-based resin (a), fluorine-based compound (b) and photopolymerization initiator (d), wherein the urethane (meth)acrylate-based resin (a) has weight average molecular weight (Mw) of 10,000 to 800,000, and the fluorine-based compound (b) has at least two polymerizable functional groups is described to be superior in self-healing property, antifouling property, and stretchability. Concrete evaluation of the antifouling property is performed on the basis of the repelling and wiping properties of the oil-based ink when the surface layer formed from the coating agent is drawn with an oil-based marker.

### SUMMARY OF INVENTION

In view of the actual outdoor environment in which PPF is used, PPF is exposed to a wide variety of pollutants. For example, after dust in the outdoor air and components in rainwater adhere to the PPF surface, non-removable water scale-like stains are formed due to the non-volatile components in the adhered components. Although the mechanism that such water scale-like stains are formed as stains that cannot be removed is not clear, it is considered to be not only that dust and ionic components in the adhered components are accumulated and stick, but also that molecular chains of the resin or the PPF surface layer are degraded and modified due to the combined influence of factors such as heat, ultraviolet rays, etc. generated by sunlight. In other words, the water scale-like stain on the PPF surface is formed by complicated mutual participation of various anomalous factors of nature and the resin of the PPF surface layer.

The complicated outdoor conditions that form such water scale-like stains cannot be reproduced by the artificial conditions that have been used in the conventional evaluation of the antifouling property of PPF. For this reason, the conventional PPF has not been studied for its property of preventing water scale-like stains (hereinafter also referred to as “water scale resistance”).

Further, in view of artificial elements that can adhere to the PPF surface, it is possible that organic solvents such as gasoline and alcohol may adhere. Therefore, in the evaluation of the antifouling property of PPF, chemical resistance to prevent swelling or appearance change with respect to gasoline and/or alcohol has been studied.

On the other hand, some organic solvents that can adhere to the PPF surface are more likely to cause swelling or appearance change due to higher solubility, and examples thereof include dichloromethane. Dichloromethane is a solvent contained in parts cleaners such as a packing stripping solution for engine rooms and a muffler gasket cleaning solution. However, under the chemical resistance conditions that have been used in the conventional evaluation of the antifouling property of PPF, a higher level of chemical resistance that can withstand dichloromethane as well (hereinafter also simply referred to as “chemical resistance”) has also not been examined.

Here, the exterior surface of the vehicle, which is the adherend of the PPF, has a complicated shape having a curved surface. PPF needs to be deformed in conformity with the exterior curved surface of a vehicle body and attached to the surface without allowing any gap to remain, and therefore, PPF presupposes to have characteristics that it stretches well along the shape of a curved surface (namely, is high in elongation at break) to allow its easy attachment (hereinafter also referred to as “processability”).

The present inventor studied the antifouling property of conventional PPF, and focused on the point that the above-mentioned water scale resistance and chemical resistance had not been satisfied. Then, the coating agent composition for forming the coating layer of PPF was attempted to have a design change in order to obtain desired water scale resistance and desired chemical resistance, resulting in the problem that the processability which PPF presupposes to have is lost. That is, it has been found that PPF has a unique problem that water scale resistance and chemical resistance are not compatible with processability.

Therefore, an object of the present disclosure is to provide a coating agent composition capable of affording a cured layer being superior in water scale resistance and chemical resistance as well as processability.

As a result of diligent study by the present inventors, they found that owing to the introduction of a specific flexible structure by designing an acrylic resin to have a hydroxyl value falling within a specific range and the introduction of an alicyclic structure in a coating agent composition for a laminated film for protecting an exterior curved surface of a vehicle, a cured layer superior in water scale resistance and chemical resistance as well as processability can be obtained. The present invention has been completed by repetitively conducting further studies on the basis of this finding.

In summary, the present disclosure provides aspects of invention as itemized below:

Item 1. A coating agent composition for a laminated film to protect an exterior curved surface of a vehicle, including

a component (A1): a (meth)acrylic resin having a hydroxyl group, and

a component (B): a polyfunctional isocyanate compound,

wherein the component (A1) has an alicyclic structure (a11) and a structure (a12) selected from the group consisting of polylactone, polycarbonate, polyester and polyether, and

the component (A1) has a hydroxyl value of 50 to 150 mg KOH/g.

Item 2. The coating agent composition according to Item 1, wherein an amount of a constitutional unit having the structure (a11) is 25 to 70 parts by mass per 100 parts by mass of the component (A1).

Item 3. The coating agent composition according to Item 1 or 2, wherein an amount of a constitutional unit having the structure (a12) is 10 to 60 parts by mass per 100 parts by mass of the component (A1).

Item 4. The coating agent composition according to any one of Items 1 to 3, wherein an equivalent ratio of the number of isocyanate groups of the component (B) to the number of hydroxyl groups of the component (A1) is 0.5 to 1.5.

Item 5. The coating agent composition according to any one of Items 1 to 3, further including a component (A2): a polyol.

Item 6. The coating agent composition according to Item 5, wherein a total hydroxyl value of the components (A1) and (A2) is 50 to 350 mg KOH/g.

Item 7. The coating agent composition according to Item 5 or 6, wherein an equivalent ratio of the number of isocyanate groups of the component (B) to the total number of hydroxyl groups in the components (A1) and (A2) is 0.5 to 1.5.

Item 8. A laminated film to protect an exterior curved surface of a vehicle, including a substrate layer having an elongation at break of 100% or more and a cured layer of the coating agent composition according to any one of Items 1 to 7 laminated on the substrate layer.

Item 9. A vehicle including an exterior curved surface to which the laminated film according to Item 8 is attached.

Using the coating agent composition of the present disclosure, it is possible to form a cured layer superior in water scale resistance and chemical resistance as well as processability. Therefore, a laminated film having the cured layer on a surface thereof can be easily attached to an exterior curved surface of a vehicle, and after such attachment, the cured layer can exhibit superior water scale resistance and chemical resistance with respect to the use environment on the vehicle surface. The mechanism by which such superior effects are obtained is not clear, but it can be explained as follows.

Regarding processability, it is conceivable that owing to the (meth)acrylic resin being designed such that the hydroxyl value thereof is within a specific range and a specific flexible structure having been introduced into the resin, parts having a lower crosslinking density and parts having a higher crosslinking density are formed (that is, coarsening and densifying of crosslinking occur) during curing, so that the exhibition of proper tenacity affects the processability.

Regarding the water scale resistance, it is conceivable that owing to an alicyclic structure having been introduced into the (meth)acrylic resin, the bulkiness of the alicyclic structure limits the mobility of molecular chains and prevents the molecular chains from degrading due to ultraviolet rays without impairing the proper tenacity of a cured film, and as a result, dust contained in the outdoor air and components in rainwater are inhibited from entering and depositing in the cured film, so that the inhibition affects the water scale resistance.

Furthermore, regarding the chemical resistance, it is conceivable that owing to an alicyclic structure having been introduced into the (meth)acrylic resin, the bulkiness of the alicyclic structure suppresses the mobility of molecular chains, and as a result, generation of voids, which will serve as permeation pathways for chemicals, is inhibited, so that the inhibition affects the chemical resistance.

### DETAILED DESCRIPTION OF THE PREFERRED EMBODIMENTS

1. Coating Agent Composition

The coating agent composition of the present disclosure is characterized by including (A1) a (meth)acrylic resin having a hydroxyl group that has a specific structure and a hydroxyl value within a specific range (hereinafter also referred to as “component (A1)” and (B) a polyfunctional isocyanate (hereinafter also referred to as “component (B)”, and being to be used for a laminated film for protecting an exterior curved surface of a vehicle. The coating agent composition of the present disclosure may further include (A2) a polyol (hereinafter also referred to as “component (A2)”). Hereinafter, the coating agent composition of the present disclosure will be described in detail. In the present description, a numerical range expressed by “to” includes the values at both ends thereof. For example, the expression “10 to 70 parts by mass” means “be 10 parts by mass or more and 70 parts by mass or less”.

1-1. (A1) Hydroxyl Group-Containing (Meth)Acrylic Resin

The coating agent composition of the present disclosure includes, as the component (A1), a (meth)acrylic resin having a hydroxyl group and having a specific structure and a hydroxyl value within a specific range. “(Meth)acrylic” is intended to include “acrylic” and “methacrylic”. Further, the (meth)acrylic resin means a polymer containing a constitutional unit derived from a (meth)acryloyl group-containing monomer. The (meth)acryloyl group-containing monomer is (meth)acrylic acid and/or (meth)acrylic acid ester, and is specifically a monomer having a structure represented by the following formula (1).

[Chemical Formula 1]

CH₂═CR—COO—R′ (1)

In formula (1), R represents a hydrogen atom or a methyl group, and R′ represents a hydrogen atom or an organic group which is optionally substituted.

The position where the hydroxyl group is bonded in the component (A1) may be any of a side chain, a main chain, a terminal, etc. It is preferable that the bonding position of the hydroxyl group is at least a side chain of the component (A1), in other words, the component (A1) has a constitutional unit derived from a monomer of the formula (1) in which the organic group of R′ is substituted with a hydroxyl group because the synthesis is easy, it is easy to adjust the hydroxyl value, and it is easy to have hydroxyl groups exist uniformly in the component (A1).

The component (A1) has an alicyclic structure (a11) (hereinafter also referred to as “structure (a11)”) and a structure (a12) selected from the group consisting of polylactone, polyether, polycarbonate and polyester (hereinafter also referred to as “structure (a12)”). Specifically, the component (A1) includes a constitutional unit derived from a (meth)acryloyl group-containing monomer having a structure (a11) and a constitutional unit derived from a (meth)acryloyl group-containing monomer having a structure (a12).

1-1-1. Constitutional Unit Having an Alicyclic Structure (a11)

The alicyclic structure (a11) contained in the component (A1) specifically constitutes a saturated alicyclic hydrocarbon group. Further, the alicyclic structure (a11) excludes a heterocycle in which oxygen, nitrogen, or the like forms a ring with carbon. When the component (A1) contains the structure (a11), it is possible to obtain superior water scale resistance and chemical resistance of a cured film. It is preferable that the structure (a11) is selected as the structure contained in the component (A1) also from the viewpoint of avoiding discoloration of a cured film.

Specific examples of the structure (a11) include a monocyclic structure and a polycyclic structure (for example, a bridged or condensed ring such as a bicyclic ring, a tricyclic ring, a tetracyclic ring, a pentacyclic ring, or a hexacyclic ring), and preferably a polycyclic structure. The number of carbon atoms of the structure (a11) is, for example, 3 to 20, preferably 4 to 15, more preferably 5 to 12, and further preferably 6 to 9. Specific examples of the monocyclic structure include cycloalkanes such as cyclopropane, cyclobutane, cyclopentane, cyclohexane, cycloheptane, cyclooctane, cyclononane, cyclodecane, cycloundecane and cyclododecane. Specific examples of the polycyclic structure include bicyclic alkanes such as norbornane, isobornane, bicycloundecane, and decahydronaphthalene (decalin); polycyclic hydrocarbons having two or more rings such as dicyclopentanyl, cubane, basketane, housane, and adamantane. In the component (A1), one type of these (a11) structures may be contained alone, or two or more types may be contained in combination.

Specific examples of the (meth)acryloyl group-containing monomer having a structure (a11) include an ester of (meth)acrylic acid with an alcohol having a structure (a11), that is, one in which R in the formula (1) is a monovalent group having the above alicyclic structure. More specific examples include cycloalkyl (meth)acrylates such as cyclopropyl (meth)acrylate, cyclobutyl (meth)acrylate, cyclopentyl (meth)acrylate, cyclohexyl (meth)acrylate, cycloheptyl (meth)acrylate, cyclooctyl (meth)acrylate, cyclononyl (meth)acrylate, cyclodecyl (meth)acrylate, cycloundecyl (meth)acrylate, cyclododecyl (meth)acrylate; norbornyl (meth)acrylate, isobornyl (meth)acrylate, bicycloundecyl (meth)acrylate, decahydronaphthyl (meth)acrylate, dicyclopentanyl (meth)acrylate, and adamantyl (meth)acrylate. In the synthesis of the component (A1), these monomers having the structure (a11) may be used singly or two or more of them may be used in combination.

Examples of commercially available (meth)acryloyl group-containing monomer having the structure (a11) include BLEMMER CHMA manufactured by NOF Corporation, FA-513AS and FA-513M manufactured by Hitachi Chemical Co., Ltd., LIGHT ESTER IB-X and LIGHT ACRYLATE IB-XA manufactured by Kyoeisha Chemical Co., Ltd., and MADA and MADMA manufactured by Osaka Organic Chemical Industry Ltd.

The amount (total amount) of the constitutional units having the structure (A1) per 100 parts by weight of the component (a11) is not particularly limited, and it may be, for example, 25 to 70 parts by mass from the viewpoint of obtaining superior water scale resistance and chemical resistance as well as processability. Further, from the viewpoint of obtaining further preferable water scale resistance and chemical resistance, the lower limit of the range of the amount of the constitutional unit is preferably 30 parts by mass or more, more preferably 40 parts by mass or more, even more preferably 45 parts by mass or more, and further preferably 48 parts by mass or more. Further, from the viewpoint of obtaining further preferable processability, the upper limit of the range of the amount of the constitutional unit is preferably 65 parts by mass or less, and more preferably 63 parts by mass or less.

1-1-2. Constitutional Unit Having a Flexible Structure (a12)

The structure (a12) selected from the group consisting of polylactone, polycarbonate, polyester and polyether contained in the component (A1) is a flexible structure which imparts flexibility to the component (A1). When the component (A1) contains the structure (a12), superior processability of a cured film can be obtained. The component (A1) may contain, as the structure (a12), one member selected from among polylactone, polycarbonate, polyester and polyether, or may contain two or more members. Among these structures (a12), polylactone, polycarbonate, and polyester are preferable, and polycarbonate is more preferable from the viewpoint of obtaining even more preferable water scale resistance and/or chemical resistance. From the viewpoint of obtaining water scale resistance and chemical resistance as well as processability with a good balance, polylactone is preferable.

The structure of polylactone may be a structure represented by the following formula (2), the structure of polycarbonate may be a structure represented by the following formula (3), and the structure of polyester may be a structure represented by the following formula (4), and the structure of the polyether may be a structure represented by the following formula (5).

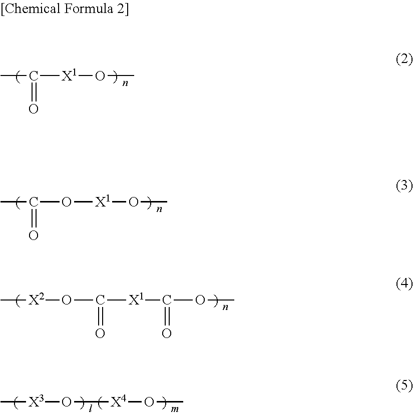

In the formulas (2) to (4), X¹ and X² are linear or branched alkylene groups which may be the same or different, preferably linear alkylene groups, and the number of their carbon atoms are preferably 3 to 7, more preferably 4 to 6, and even more preferably 5. Further, n is an integer of 1 or more, preferably 1 to 10, more preferably 2 to 8, and even more preferably 2 to 5.

In the formula (5), X³ and X⁴ are linear or branched alkylene groups which may be the same or different (preferably linear alkylene groups), and the number of their carbon atoms are preferably 2 to 7, more preferably 2 to 5, even more preferably 2 to 4, and particularly preferably 2. Further, the sum of 1 and m is preferably 1 to 20, more preferably 2 to 10, even more preferably 2 to 8, and further preferably 2 to 5.

Among the structures represented by the formulas (2) to (5), the polylactone represented by the formula (2), the polycarbonate represented by the formula (3), and the polyether represented by the formula (5) can form a terminal hydroxyl group, and they are preferable in that the effects of the present disclosure can be obtained even more preferably. In these cases, in the (meth)acryloyl group-containing monomers to be used in the synthesis of the component (A1), a polylactone, a polycarbonate and a polyether each having a terminal hydroxyl group and represented by the following formula (2a), (3a) and (5a), respectively, each form R′ in the formula (1).

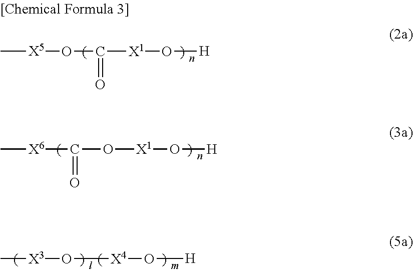

In the formula (2a), X¹ is as described for the formula (2). X⁵ is a linear or branched alkylene group (preferably a linear alkylene group), and the number of the carbon atoms thereof is preferably 2 to 7, more preferably 2 to 5, more preferably 2 to 4, and particularly preferably 2. Further, n is as described for the equation (2). In the formula (3a), X¹ is as described for the formula (3). X⁶ is a linear or branched alkylene group (preferably a linear alkylene group), and the number of the carbon atoms thereof is preferably 2 to 7, more preferably 2 to 5, and further preferably 2 to 4. Further, n is as described for the formula (3). In the formula (5a), X³ and n are as described for the formula (5).

Examples of commercially available products of the (meth)acryloyl group-containing monomer having a flexible structure represented by the formula (2a) include PLACCEL F series (polycaprolactone-modified hydroxy(meth)acrylate) manufactured by Daicel Corporation, and preferably include PLACCEL FA2D (polycaprolactone-modified hydroxyethyl acrylate; caprolactone 2 mol adduct) and PLACCEL FAS (polycaprolactone-modified hydroxyethyl acrylate; caprolactone 5 mol adduct). Examples of commercially available products of the (meth)acryloyl group-containing monomer having a flexible structure and a hydroxyl group represented by the formula (3a) include PLACCEL HEMAC1 manufactured by Daicel Corporation, etc. as commercially available products of a mixture of (3-hydroxy-2,2-dimethyl-propoxycarbonyloxy)-alkyl (meth)acrylate and 2-hydroxyethyl methacrylate. Examples of commercially available products of the (meth)acryloyl group-containing monomer having a flexible structure and a hydroxyl group represented by the formula (5a) include BLEMMER PE-90, 200, 350, 350G, 1000, 500, 800 (polyethylene glycol monomethacrylate), BLEMMER 50E-300 (polyethylene glycol-propylene glycol-monomethacrylate), BLEMMER 55PET-800 (polyethylene glycol-tetramethylene glycol-monomethacrylate), BLEMMER 10PPB-500B (propylene glycol-polybutylene glycol-monomethacrylate), BLEMMER AE-90U, 200, 400 (polyethylene glycol monoacrylate), and BLEMMER AP-400, 550, 800 (polypropylene glycol monoacrylate), all manufactured by NOF Corporation.

In the synthesis of the component (A1), these monomers having the structure (a12) may be used singly or two or more of them may be used in combination. Since the structure (a12) imparts superior processability to a cured film due to its flexibility, there is a tendency that the longer its chain length (n in the formulas (2) to (5) is, for example, 4 or more, preferably 5 or more), the better the processability to be exhibited. On the other hand, from the viewpoint of maintaining superior water scale resistance and chemical resistance, a shorter chain length (n in the formulas (2) to (5) is, for example, 3 or less, preferably 2 or less) tends to be preferable. In view of these points, it is preferable that the component (A1) contains a combination of structures having different chain lengths as the structure (a12).

The amount (total amount) of the constitutional unit having the structure (a12) per 100 parts by mass of the component (A1) is not particularly limited, and, for example, may be 10 to 60 parts by mass. Further, from the viewpoint of obtaining further preferable processability, the lower limit of the range of the constitutional unit amount is preferably 15 parts by mass or more, more preferably 20 parts by mass or more, even more preferably 25 parts by mass or more, further preferably 30 parts by mass, and particularly preferably 33 parts by mass or more. Further, from the viewpoint of obtaining further preferable water scale resistance and chemical resistance, the upper limit of the range of the constitutional unit amount is preferably 50 parts by mass or less, more preferably 45 parts by mass or less, and even more preferably 40 parts by mass or less.

The ratio of the amount of the constitutional unit having the structure (a12) to the amount of the constitutional unit having the structure (a11) is determined depending on the above-described usage amounts, and from the viewpoint of more efficiently obtaining the water scale resistance and the chemical resistance as well as the processability, it is 0.1 to 2.0, preferably 0.1 to 1.5, and more preferably 0.1 to 1.2.

1-1-3. Other Constitutional Units

The component (A1) may further include at least any constitutional unit selected from among a constitutional unit derived from a (meth)acryloyl group-containing monomer having a hydroxyl group, a constitutional unit derived from a (meth)acryloyl group-containing monomer having no hydroxyl group, and a constitutional unit derived from a (meth)acryloyl group-containing monomer having a polysiloxane structure in a side chain thereof other than the constitutional units shown in 1-1-1 and 1-1-2 above, and constitutional units derived from monomers other than (meth)acryloyl group-containing monomers.

1-1-3-1. Constitutional Unit Derived from a (Meth)Acryloyl Group-Containing

Monomer Having a Hydroxyl Group

Examples of the (meth)acryloyl group-containing monomer having a hydroxyl group include a (meth)acryloyl group-containing monomer having a hydroxyl group in a side chain thereof, and specifically, monomers in which R′ in the above formula (1) is a hydroxyalkyl group having 1 to 6 carbon atoms. Examples of the hydroxyalkyl group having 1 to 6 carbon atoms include hydroxymethyl group, hydroxyethyl group, hydroxypropyl group, and hydroxybutyl group, and preferably hydroxy chain-like alkyl groups such as hydroxymethyl group, 2-hydroxyethyl group, 3-hydroxy-n-propyl group, and 4-hydroxy-n-butyl group, and more preferably 2-hydroxyethyl group and 4-hydroxy-n-butyl group.

The component (A1) may include one type or two or more types of constitutional units derived from these monomers.

When the component (A1) includes the constitutional unit derived from a (meth)acryloyl group-containing monomer having a hydroxyl group other than the constitutional units shown in 1-1-1 and 1-1-2 above, the amount of the constitutional unit per 100 parts by mass of the component (A1) may be appropriately set according to the hydroxyl value which the component (A1) should satisfy, and it may be, for example, 5 to 20 parts by mass, preferably 8 to 17 parts by mass, and even more preferably 10 to 15 parts by mass.

1-1-3-2. Constitutional Unit Derived from a (Meth)Acryloyl Group-Containing Monomer Having No Hydroxyl Group

Specific examples of the (meth)acryloyl group-containing monomer containing no hydroxyl group include (meth)acrylic acid and (meth)acrylic acid esters. When the component (A1) includes a constitutional unit derived from a (meth)acryloyl group-containing monomer containing no hydroxyl group, the component (A1) may include either or both of (meth)acrylic acid and (meth)acrylic acid ester, and preferably includes constitutional units derived from both of them.

The component (A1) may include either one of a constitutional unit derived from acrylic acid and a constitutional unit derived from methacrylic acid, or constitutional units derived from both of these acids.

When the component (A1) includes a constitutional unit derived from (meth)acrylic acid, the amount of the constitutional unit derived from (meth)acrylic acid per 100 parts by mass of the component (A1) is, for example, 0.3 to 1.5 parts by mass, and preferably 0.6 to 1.2 parts by mass.

The (meth)acrylic acid ester is a monomer in which R′ in the formula (1) is a monovalent alkyl group. Examples of the monovalent alkyl group include linear or branched alkyl groups having 1 to 10 carbon atoms, preferably 1 to 8 carbon atoms, more preferably 3 to 8, and even more preferably 4 to 8, and specifically methyl group, ethyl group, n-propyl group, isopropyl group, butyl group, sec-butyl group, tert-butyl group, isobutyl group, amyl group, isoamyl group, tert-amyl group, hexyl group, 2-hexyl group, 3-hexyl group, heptyl group, 2-heptyl group, 3-heptyl group, isoheptyl group, tert-heptyl group, n-octyl group, isooctyl group, tert-octyl group, 2-ethylhexyl group, nonyl group, isononyl group, and decyl group.

The component (A1) may include one type or two or more types, preferably two or more types of these monomer-derived constitutional units.

When the component (A1) includes a constitutional unit derived from (meth)acrylic acid ester, the amount of the constitutional unit derived from (meth)acrylic acid ester per 100 parts by mass of the component (A1) is, for example, 2 to 50 parts by mass, and preferably 5 to 45 parts by mass.

Further, when the component (A1) includes constitutional units derived from (meth)acrylic acid and (meth)acrylic acid ester, the total used amount of the (meth)acrylic acid monomer and the (meth)acrylic acid ester monomer per 100 parts by mass of the component (A1) is, for example, 2 to 50 parts by mass, and preferably 5 to 45 parts by mass.

1-1-3-3. Constitutional Unit Derived from a (Meth)Acryloyl Group-Containing Monomer Having a Polysiloxane Structure in a Side Chain Thereof

The (meth)acryloyl group-containing monomer having a polysiloxane structure in a side chain thereof is just required to be any (meth)acryloyl group-containing monomer having one or more polysiloxane chains in a side chain thereof, and specific examples thereof include monomers wherein R′ in the formula (1) is formed of a group represented by the following formula (6a), (6b) or and (6c), and the formula (6a) is preferable.

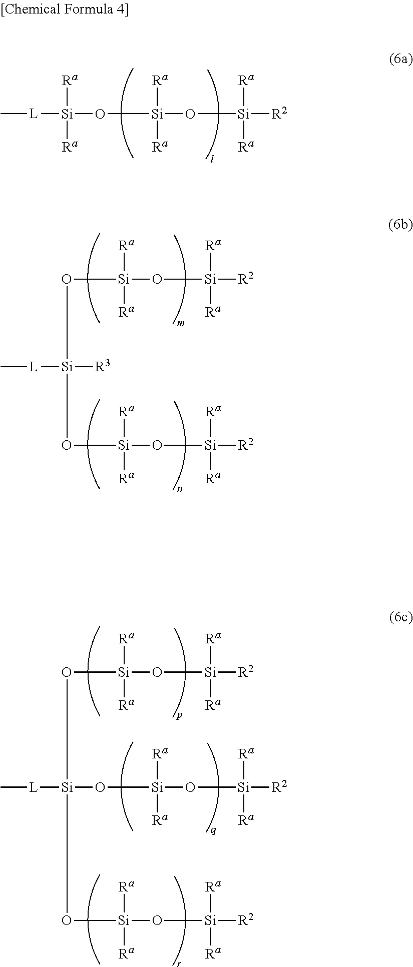

In the above formulas (6a), (6b) and (6c), L is a divalent linking group; each R^{a} is independently a hydrogen atom or a monovalent organic group; when there are a plurality of R², each of them is independently a hydrogen atom or a monovalent organic group; R³ is a hydrogen atom or a monovalent organic group; 1, m, n, p, q and r are each independently an integer of 0 to 1000.

Examples of the divalent linking group of L include an alkylene group, an ester group, an ether group, and a group in which two or more of these are linked, preferably an alkylene group, and more preferably an alkylene group having 1 to 10, even more preferably 1 to 6, further preferably 2 to 3 carbon atoms. The alkylene group may be either linear or branched, and is preferably linear.

As R^{a} and R³, monovalent organic groups are preferable, and alkyl groups, alkoxy groups, alkylcarbonyl groups, alkoxycarbonyl groups, and alkylcarbonyloxy groups are more preferable. Alkyl groups are even more preferable, and alkyl groups having 1 to 5 carbon atoms, preferably 1 to 3 carbon atoms are further preferable.

As R², monovalent organic groups are preferable, and alkyl groups, alkoxy groups, alkylcarbonyl groups, alkoxycarbonyl groups, and alkylcarbonyloxy groups are more preferable. Alkyl groups are even more preferable, and alkyl groups having 1 to 5 carbon atoms, preferably 1 to 4 carbon atoms are further preferable.

l is preferably 1 to 1000, more preferably 6 to 300, and further preferably 30 to 80. As m, n, p, q and r, 0 to 1000 are preferable, and 0 to 300 are more preferable.

Examples of a commercially available product of the (meth)acryloyl group-containing monomer having a polysiloxane structure in a side chain thereof include Silaplane FM-0711 (in the formula (6a), L is a n-propylene group, 1=9.6, R^{a} is a methyl group, R² is a n-butyl group, and molecular weight is 1000), Silaplane FM-0721 (in the formula (6a), L is a n-propylene group, 1=63.6, R^{a} is a methyl group, R² is a n-butyl group, and molecular weight is 5000), Silaplane FM-0725 (in the formula (6a), L is a n-propylene group, 1=131, R^{a} is a methyl group, R² is a n-butyl group, and molecular weight is 10000), and Silaplane TM-0701T (in the formula (6c), p=q=r=0, R^{a} and R² are methyl groups, and molecular weight is 423), which are methacryl group-containing monomers manufactured by JNC Corporation.

The component (A1) may include one type or two or more types of constitutional units derived from these monomers.

Owing to the component (A1) containing a constitutional unit derived from a (meth)acryloyl group-containing monomer having a polysiloxane structure in a side chain thereof, water repellency can be imparted to the surface of a cured film, so that more favorable antifouling property can be exhibited.

When the component (A1) contains a constitutional unit derived from a (meth)acryloyl group-containing monomer having a polysiloxane structure in a side chain thereof, the amount of the constitutional unit per 100 parts by mass of the component (A1) is, for example, 1 to 10 parts by mass, and preferably 3 to 8 parts by mass.

1-1-3-4. Constitutional Units Derived from a Monomer Other than (Meth)Acryloyl Group-Containing Monomers

The monomers other than (meth)acryloyl group-containing monomers are specifically ethylenically unsaturated monomers, and more specific examples include vinyl monomers such as vinyl acetate and vinyl propionate; unsaturated carboxylic acid monomers such as itaconic acid, maleic acid, and fumaric acid; and aromatic monomers such as styrene. Among these, the vinyl monomers and the unsaturated carboxylic acid monomers are preferable from the viewpoint of avoiding discoloration of a cured film.

The component (A1) may include one type or two or more types of constitutional units derived from these monomers.

From the viewpoint of sufficiently obtaining the effects derived from the component (A1), the component (A1) preferably contains no constitutional units derived from monomers other than (meth)acryloyl group-containing monomers, but if any, the amount of the constitutional units derived from the monomers other than the (meth)acryloyl group-containing monomers per 100 parts by mass of the component (A1) is, for example, less than 20 parts by mass, preferably less than 10 parts by mass, and more preferably less than 1 part by mass.

1-1-4. Synthesis of Component (A1)

The component (A1) can be synthesized by a known polymerization method using a monomer to give the above-described constitutional unit having the structure (a11), a monomer to give the above-described constitutional unit having the structure (a12), and, if necessary, a monomer to give the above-described other constitutional unit. In this case, for example, when synthesizing the component (A1) in which the amount of the constitutional unit having the structure (a11) is 25 to 70 parts by mass per 100 parts by mass of the component (A1), the polymerization reaction may be performed by feeding a monomer having the structure (a11) such that the amount thereof is 25 to 70 parts by mass per 100 parts by mass of all the monomers to be used for the synthesis of the component (A1).

The component (A1) can also be synthesized by synthesizing a (meth)acrylic resin having the structure (a11) but not having the structure (a12) by a known polymerization method using a (meth)acrylic monomer not having the structure (a12) instead of the monomer to give a constitutional unit having the structure (a12), and then modifying the (meth)acrylic resin having the structure (a11) but not having the structure (a12) with a compound having the structure (a12).

The polymerization method may usually be radical polymerization. The polymerization mode may be any of known polymerization modes such as solution polymerization, suspension polymerization, emulsion polymerization, etc. Among these polymerization modes, it is preferable to use solution polymerization from the viewpoint of precise control of polymerization, etc.

As the polymerization initiator for radical polymerization, known agents can be used. Examples thereof include azo initiators such as 2,2′-azobis(isobutyronitrile) (AIBN), 2,2′-azobis(2-methylbutyronitrile) (AMBN), 2,2′-azobis(2,4-dimethylvaleronitrile) (ADVN), 1,1′-azobis(cyclohexane-1-carbonitrile) (ACHN), dimethyl-2,2′-azobisisobutyrate (MAIB), 4,4′-azobis(4-cyanovaleric acid)) (ACVA), 1,1′-azobis(1-acetoxy-1-phenylethane), 2,2′-azobis(2-methylbutylamide), 2,2′-azobis(4-methoxy-2,4-dimethylvaleronitrile), 2,2′-azobis(2-methylamidinopropane) dihydrochloride, 2,2′-azobis [2-(2-imidazolin-2-yl)propane], 2,2′-azobis [2-methyl-N-(2-hydroxyethyl)propionamide], 2,2′-azobis(2,4,4-trimethylpentane), 2-cyano-2-propylazoformamide, 2,2′-azobis(N-butyl-2-methylpropionamide), and 2,2′-azobis(N-cyclohexyl-2-methylpropionamide), peroxide initiators such as benzoyl peroxide, t-butyl peroxyoctanoate, diisobutyl peroxide, di(2-ethylhexyl) peroxypivalate, decanoyl peroxide, t-butyl peroxy-2-ethylhexanoate, and t-butyl peroxybenzoate, and redox initiators in which an oxidizing agent and a reducing agent are combined, such as a combination of hydrogen peroxide and iron(II) salt, and a combination of a persulfate and sodium hydrogen sulfite. These polymerization initiators may be used singly or two or more of them may be used in combination.

Among these polymerization initiators, the azo initiators are preferable, and 1,1′-azobis(cyclohexane-1-carbonitrile) (ACHN) is more preferable.

The used amount of the polymerization initiator is not particularly limited, and it may be, for example, 0.001 to 10 parts by mass, preferably 0.01 to 8 parts by mass, more preferably 0.1 to 6 parts by mass, and further preferably 0.5 to 5 parts by mass, per 100 parts by mass of the total amount of the monomers to be polymerized.

In the polymerization reaction, known chain transfer agents, polymerization inhibitors, molecular weight modifiers, etc. may be used as appropriate. Furthermore, the polymerization reaction may be carried out in one step or in two or more steps. The temperature of the polymerization reaction is not particularly limited, and may be, for example, 50° C. to 200° C., preferably 80° C. to 150° C., and more preferably 100 to 130° C.

1-1-5. Hydroxyl value of component (A1) The hydroxyl value of the component (A1) is 50 to 150 mg KOH/g. If the hydroxyl value is less than 50 mg KOH/g, the crosslinking density in a cured film will be insufficient, so that desired water scale resistance and chemical resistance cannot be obtained. On the other hand, when the hydroxyl group exceeds 150 mg KOH/g, the crosslinking density in a cured film becomes excessively high, so that the flexibility cannot be maintained and desired processability cannot be obtained.

The coating agent composition of the present disclosure may optionally further include (A2) a component having a hydroxyl group, and when the component (A2) is further contained, the hydroxyl value of the entire coating agent composition varies depending upon the hydroxyl value of the component (A2). With respect to the hydroxyl value, however, regardless of whether or not the component (A2) is contained, the achievement of water scale resistance and chemical resistance as well as processability is dominantly affected by rather the hydroxyl value of the component (A1) than the hydroxyl value of the entire coating agent composition.

From the viewpoint of more preferably obtaining both water scale resistance and chemical resistance, the lower limit of the above range of the hydroxyl value of the component (A1) is preferably 71 mg KOH/g or more, more preferably 75 mg KOH/g or more, even more preferably 80 mg KOH/g or more, still even more preferably 90 mg KOH/g or more, and further preferably 100 mg KOH/g or more.

From the viewpoint of obtaining more preferable processability, the upper limit of the above range of the hydroxyl value of the component (A1) is preferably 150 mg KOH/g or less, more preferably 110 mg KOH/g or less, even more preferably 100 mg KOH/g or less, and further preferably 83 mg KOH/g or less.

In the present description, “hydroxyl value” is a value determined in accordance with the method specified in “7.1 Neutralization titration method” contained in JIS K 0070 “Test methods for acid value, saponification value, ester value, iodine value, hydroxyl value and unsaponifiable matter of chemical products”. When calculating a hydroxyl value, an acid value is also required, and the acid value can also be calculated in accordance with the method specified in “3.1 Neutralization titration method” of the JIS standard cited above.

1-1-6. Molecular Weight of Component (A1)

The molecular weight of the component (A1) can be appropriately set according to the hydroxyl value of the component (A1) as well as the water scale resistance, chemical resistance and processability. Specifically, the number average molecular weight (Mn) of the component (A1) is, for example, 1000 to 15000, preferably 3000 to 10000, and more preferably 5000 to 6500. The weight average molecular weight (Mw) of the component (A1) is, for example, 10000 to 50000, preferably 20000 to 40000, and more preferably 15000 to 32000. The polydispersity (weight average molecular weight Mw/number average molecular weight Mn) of the component (A1) is, for example, 1 to 7, preferably 1.5 to 6, more preferably 2 to 5.5, and further preferably 3.5 to 5.3.

The number average molecular weight (Mn) and the weight average molecular weight (Mw) of the component (A1) can be adjusted by conditions such as the polymerization reaction time, the reaction temperature and the amount of the polymerization initiator used. The number average molecular weight (Mn) and the weight average molecular weight (Mw) are values measured in terms of standard polystyrene by gel permeation chromatography (GPC).

1-1-7. Glass Transition Temperature of Component (A1)

The glass transition temperature of the component (A1) is not particularly limited, and from the viewpoint of processability and/or chemical resistance, it is, for example, −20 to 100° C., preferably −5 to 80° C., and more preferably 5 to 40° C.

The glass transition temperature of the component (A1) can be determined on the basis of the following formula known as Fox's formula.

1/Tg=(W₁/Tg₁)+(W₂/Tg₂)+(W₃/Tg₃)+ . . . +(Wₙ/Tgₙ) [Equation 1]

In the above formula, Tg represents the glass transition temperature (K) of the component (A1), W₁, W₂, W₃, . . . , and Wₙ represent the mass fractions of the respective monomers used for the component (A1), and Tg₁, Tg₂, Tg₃, . . . , and Tgₙ represent the glass transition temperatures (K) of homopolymers obtained from the monomers corresponding to the mass fractions of the respective monomers. According to the above formula, the glass transition temperature can be determined using only the monomer information whose glass transition temperature is known.

1-2. Polyol (A2)

The coating agent composition of the present disclosure may further include a polyol as the component (A2). Due to further inclusion of a flexible and elastic component (A2), the coating agent composition of the present disclosure can dramatically improve the processability of a cured film by further coarsening the crosslinking during curing and can minimize the deterioration of water scale resistance and chemical resistance, which are generally in a trade-off relationship with processability, so that comprehensively, the processability can be satisfied more favorably with the water scale resistance and the chemical resistance. Further, the component (A2) can also contribute to enhancing the scratch resistance of a cured film.

The polyol is not particularly limited as long as it is a compound having two or more hydroxyl groups in one molecule, and examples thereof include compounds preferably containing 2 to 6 hydroxyl groups, and more preferably 2 to 4 hydroxyl groups.

Preferred examples of the component (A2) include polylactone polyol, polycarbonate polyol, polyester polyol and polyether polyol. Since these components are more moderately flexible and have more preferable elasticity, they are preferable in that processability can be more favorably made compatible with water scale resistance and chemical resistance. As the component (A2), one species selected from among polylactone polyols, polycarbonate polyols, polyester polyols and polyether polyols may be used alone, or two or more species may be used in combination. From the viewpoint of more favorably making processability compatible with water scale resistance and chemical resistance, polylactone polyols, polycarbonate polyols and polyester polyols are preferable as the component (A2).

The polylactone polyol is not particularly limited as long as it is a compound having a ring-opening structure of lactone and two or more hydroxyl groups in one molecule, and examples thereof include polyols represented by any of the following formulas (7a) to (7c).

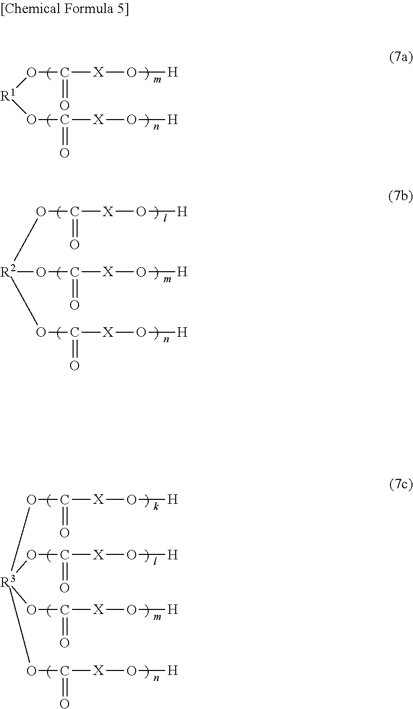

In the formula (7a), R¹ represents a divalent organic group. Examples of the divalent organic group include linear alkylene groups such as —CH₂—, —C₂H₄—, branched alkylene groups such as —CH₂—C(CH₃)₂—CH₂—, and ether-containing groups such as —C₂H₄—O—C₂H₄—. X's represent linear or branched alkylene groups which may be the same or different, and preferably represent linear alkylene groups. The number of the carbon atoms of the alkylene groups are preferably 3 to 7, more preferably 4 to 6, and even more preferably 5. Furthermore, m and n each represent an integer of 1 or more, preferably an integer of 2 to 20, and the sum of m and n is preferably 4 to 35.

In the formula (7b), R² represents a trivalent organic group. Examples of the trivalent organic group include a structure in which three hydrogen atoms have been removed from a linear or branched alkane. X's represent linear or branched alkylene groups which may be the same or different, and preferably represent linear alkylene groups. The number of the carbon atoms of the alkylene groups are preferably 3 to 7, more preferably 4 to 6, and even more preferably 5. Furthermore, 1, m and n each represent an integer of 1 or more, preferably an integer of 2 to 20, and the sum of 1, m and n is preferably 3 to 40.

In the formula (7c), R³ represents a tetravalent organic group. Examples of the tetravalent organic group include a structure in which four hydrogen atoms have been removed from a linear or branched alkane. X's represent linear or branched alkylene groups which may be the same or different, and preferably are linear alkylene groups. The number of the carbon atoms of the alkylene groups are preferably 3 to 7, more preferably 4 to 6, and even more preferably 5. Furthermore, k, l, m and n each represent an integer of 1 or more, preferably an integer of 2 to 20, and the sum of k, l, m and n is preferably 4 to 50.

These polylactone polyols may be used singly or two or more of them may be used in combination.

Examples of commercially available polylactone polyols represented by formulas (7a) to (7c) include PLACCEL 200 series (polycaprolactonediol), PLACCEL 300 series (polycaprolactonetriol), and PLACCEL 400 series (polycaprolactonetetraol) manufactured by Daicel Corporation.

The polycarbonate polyol is not particularly limited as long as it is a compound having a carbonate group represented by —O—(C═O)—O— and two or more (preferably two) hydroxyl groups in one molecule. The polycarbonate polyol can be obtained by reacting one or more kinds of polyol raw materials (polyhydric alcohols) with a carbonic acid ester or phosgene (preferably a carbonic acid ester). Examples of the polyol raw material include aliphatic polyols, alicyclic polyols, and aromatic polyols, preferably include aliphatic polyols, and more preferably include linear or branched diols having 2 to 10 carbon atoms such as 1,5-pentanediol, 3-methyl-1,5-pentanediol, 1,6-hexanediol, and 1,9-nonanediol. Examples of the carbonic acid ester include aliphatic carbonates such as dimethyl carbonate and diethyl carbonate, aromatic carbonates such as diphenyl carbonate, and cyclic carbonates such as ethylene carbonate, and preferably include aliphatic carbonates. Dimethyl carbonate is more preferable.

Examples of commercially available polycarbonate polyols include DURANOL series (polycarbonate diols) manufactured by Asahi Kasei Corporation, ETERNACOLL UM series (polycarbonates made from 1,4-cyclohexanedimethanol and 1,6-hexanediol) manufactured by Ube Industries, Ltd., and Kuraray Polyol C series (polycarbonates prepared using 3-methyl-1,5-pentanediol and 1,6-hexanediol as polyol raw materials) manufactured by Kuraray Co., Ltd.

The polyester polyol is not particularly limited as long as it is a compound having an ester group (—COO— or —OCO—) and two or more (preferably two) hydroxyl groups in one molecule. The polyester polyol can be obtained by a reaction of one or more polyol raw materials (polyhydric alcohols) with an ester-forming compound such as polycarboxylic acid or its ester, anhydride and halide. Examples of the polyol raw material include the same polyol raw materials as the above-mentioned polycarbonate polyol raw materials. Examples of the ester-forming compound such as polycarboxylic acid or its ester, anhydride and halide include polycarboxylic acids such as aliphatic dicarboxylic acids, aromatic dicarboxylic acids, alicyclic dicarboxylic acids and tricarboxylic acids, and acid anhydrides, halides, and lower ester compounds of these polycarboxylic acids, and more preferably include aliphatic dicarboxylic acids such as adipic acid and sebacic acid, and aromatic dicarboxylic acids such as terephthalic acid and isophthalic acid.

These polyester polyols may be used singly or two or more of them may be used in combination.

Examples of commercially available polyester polyols include Kuraray Polyol P series (polyester polyols made from 3-methyl-1,5-pentanediol and one or more dicarboxylic acids selected from the group consisting of adipic acid, terephthalic acid, isophthalic acid and sebacic acid) manufactured by Kuraray Co., Ltd., and Kuraray polyol F series (trifunctional polyester polyols made from 3-methyl-1,5-pentanediol, 1,9-nonanediol and adipic acid).

The polyether polyol is not particularly limited as long as it is a compound having an ether bond (—O—) and two or more (preferably two) hydroxyl groups in one molecule. Examples thereof include polyethylene glycol, polypropylene glycol, polytetramethylene glycol, a random copolymer or block copolymer having ethylene oxide units and propylene oxide units, and a random copolymer or block copolymer having ethylene oxide units and butylene oxide units.

These polyether polyols may be used singly or two or more of them may be used in combination.

Examples of commercially available polyether polyols include PTMG series (polytetramethylene ether glycol) manufactured by Mitsubishi Chemical.

The hydroxyl value of the component (A2) is, for example, 50 to 600, preferably 80 to 360, and more preferably 120 to 320.

The number average molecular weight of the polyol may be appropriately set on the basis of the hydroxyl value of the component (A2). Specifically, the number average molecular weight of the polyol is, for example, 100 to 3000, preferably 300 to 2000, and more preferably 500 to 1000. The number average molecular weight is a value measured in terms of standard polystyrene by gel permeation chromatography (GPC).

When the coating agent composition of the present disclosure includes the component (A2), the total hydroxyl value of the component (A1) and the component (A2) (that is, the hydroxyl value of a uniform mixture of the component (A1) and the component (A2)) is, for example, 50 to 350 mg KOH/g.

The lower limit of the above-mentioned range of the total hydroxyl value of the components (A1) and (A2) is preferably 80 mg KOH/g or more, more preferably 110 mg KOH/g or more, even more preferably 140 mg KOH/g or more, and further preferably 150 mg KOH/g or more, from the viewpoint of obtaining further preferable water scale resistance and chemical resistance.

The upper limit of the above-mentioned range of the total hydroxyl value of the components (A1) and (A2) is preferably 250 mg KOH/g or less, more preferably 200 mg KOH/g or less, even more preferably 180 mg KOH/g or less, and further preferably 160 mg KOH/g or less, from the viewpoint of obtaining further preferable processability.

The content of the component (A2) may be appropriately determined on the basis of the above-mentioned number average molecular weight and hydroxyl value, and it is, for example, 20 to 350 parts by mass, preferably 30 to 300 parts by mass, more preferably 50 to 200 parts by mass, even more preferably 70 to 150 parts by mass, and further preferably 80 to 120 parts by mass, per 100 parts by mass of the component (A1).

1-3. (B) Polyfunctional Isocyanate Compound

The polyfunctional isocyanate compound as the component (B) forms a urethane bond to cure the coating agent composition as a result of reacting with hydroxyl groups of the component (A1) or hydroxyl groups of both the component (A1) and the component (A2).

Examples of the polyfunctional isocyanate compound include polyfunctional isocyanates and (meth)acrylic resins copolymerized with a monomer having an isocyanate group, and either of them or both of them in combination may be used.

The polyfunctional isocyanate compound is a compound containing 2 or more, preferably 2 to 6, more preferably 2 to 4 isocyanate groups (including isocyanate groups protected by leaving groups; the same applies hereinafter) in one molecule thereof.

Specific examples of the polyfunctional isocyanates include aliphatic diisocyanates such as lysine isocyanate, hexamethylene diisocyanate and trimethylhexane diisocyanate; alicyclic diisocyanates such as hydrogenated xylylene diisocyanate, isophorone diisocyanate, methylcyclohexane-2,4-(or 2,6)-diisocyanate, 4,4′-methylenebis(cyclohexylisocyanate) and 1,3-(isocyanatomethyl)cyclohexane; trifunctional or higher functional isocyanates such as lysine triisocyanate, and their multimers (polyisocyanate). These polyfunctional isocyanate compounds may be used singly, or two or more of them may be used in combination.

The component (B) is more preferably the polyisocyanate. Examples of the polyisocyanate include isocyanurate modified products [e.g., IPDI (isophorone diisocyanate) isocyanurate and HDI (hexamethylene diisocyanate) isocyanurate]; adduct modified products [e.g., trimethylolpropane adduct of TDI (tolylene diisocyanate), trimethylol propane adduct of HDI (hexamethylene diisocyanate), trimethylol propane adduct of xylylene diisocyanate (XDI), and trimethylol propane adduct of IPDI (isophorone diisocyanate)]; biuret modified products [e.g., HDI (hexamethylene diisocyanate) biuret]. These polyisocyanates may be used singly, or two or more of them may be used in combination.

As commercially available products of the polyisocyanates, examples of the isocyanurate of hexamethylene diisocyanate include DURANATE TPA-100 and TKA-100 manufactured by Asahi Kasei Corporation, Desmodur N3300 manufactured by Bayer, Basonat HI-100 manufactured by BASF, and CORONATE HX manufactured by Tosoh Corporation; examples of the isocyanurate of isophorone diisocyanate include Vestanat T1890 manufactured by Evonik and Desmodur Z4470BA manufactured by Bayer; examples of the isocyanurate of xylylene diisocyanate include TAKENATE D-131N manufactured by Mitsui Chemicals, Inc.; examples of the adduct of hexamethylene diisocyanate include Duranate P301-75E manufactured by Asahi Kasei Corporation; examples of the adduct of isophorone diisocyanate include TAKENATE D-140N manufactured by Mitsui Chemicals Inc.; examples of the biuret of hexamethylene diisocyanate include Duranate 24A-100 and 22A-75PX manufactured by Asahi Kasei Corporation, Desmodur N75 and N3200 manufactured by Bayer, Basonat HB-100 manufactured by BASF, and Tolonate HDB manufactured by Vencorex.

Among these polyisocyanates, from the viewpoint of better compatibility of water scale resistance and chemical resistance with processability, isocyanurate modified products or adduct modified products are preferable, isocyanurate of hexamethylene diisocyanate, isocyanurate of xylylene diisocyanate, and adduct of hexamethylene diisocyanate are more preferable, and isocyanurate of hexamethylene diisocyanate is more preferable.

The (meth)acrylic resin copolymerized with a monomer having an isocyanate group is a (meth)acrylic resin containing two or more constitutional units derived from a monomer having an isocyanate group (including an isocyanate group protected by a leaving group; the same applies hereinafter) in one molecule. The (meth)acrylic resin copolymerized with a monomer having an isocyanate group can be obtained by copolymerizing a (meth)acrylic monomer and a monomer having an isocyanate group by a known method.

Examples of the monomer having an isocyanate group include 2-isocyanatoethyl (meth)acrylate and [(meth)acryloyloxyalkyloxy]ethylisocyanate, and 2-isocyanatoethyl (meth)acrylate is preferable.

Examples of commercially available products of the monomer having an isocyanate group include Karenz MOI and Karenz AOI manufactured by Showa Denko K.K. as 2-isocyanatoethyl (meth)acrylate; and Karenz MOI-EG manufactured by Showa Denko K.K. as [(meth)acryloyloxyalkyloxy]ethyl isocyanate.

The component (B) may be a blocked isocyanate. In particular, when the coating agent composition of the present disclosure is in the form of a one-component type, the composition preferably contains a blocked isocyanate as the component (B) from the viewpoint of preservability (preservability with time).

The blocked isocyanate is a compound in which some or all of the isocyanate groups of the above isocyanate compound are protected by leaving groups. Examples of the blocking agent for forming the leaving groups (protecting groups) include known blocking agents, for example, phenol-based, alcohol-based, active methylene-based, mercaptan-based, acid amide-based, lactam-based, acid imide-based, imidazole-based, pyrazole-based, urea-based, oxime-based, and amine-based compounds. More specifically, examples of the blocking agent include phenol compounds such as phenol, cresol and ethylphenol; alcohol compounds such as propylene glycol monomethyl ether, ethylene glycol, benzyl alcohol, methanol and ethanol; active methylene-based compounds such as dimethyl malonate and acetylacetone; mercaptan compounds such as butyl mercaptan and dodecyl mercaptan; acid amide compounds such as acetanilide and acetic acid amide; lactam compounds such as ε-caprolactam and δ-valerolactam; acid imide compounds such as succinimide and maleimide; pyrazole compounds such as 3,5-dimethylpyrazole, 4-nitro-3,5-dimethylpyrazole and 4-benzyl-3,5-dimethylpyrazole; oxime compounds such as acetoaldoxime, acetone oxime and methyl ethyl ketoxime; and amine compounds such as diphenylaniline, aniline and ethyleneimine.

The amount of the isocyanate groups contained in the component (B) can be expressed by the ratio of the mass of the isocyanate groups (—NCO) to the entire component (B). The ratio of the mass of the isocyanate groups to the component (B) (NCO %) is preferably 5 to 50%, more preferably 8 to 30%, even more preferably 12 to 25%, and further preferably 16 to 23%.

In the coating agent composition of the present disclosure, the equivalent ratio of the number of the isocyanate groups (including the blocked isocyanate groups) of the component (B) to the number of the hydroxyl groups of the component (A1), in the case of further including the component (A2), the equivalent ratio of the number of the isocyanate groups (including the blocked isocyanate groups) of the component (B) to the total number of hydroxyl groups of the components (A1) and (A2) (hereinafter, also referred to as “isocyanate index”) is, for example, 0.5 to 1.5.

It is preferable that the isocyanate index is equal to or more than the lower limit of the above-mentioned range in terms of improving the water scale resistance and chemical resistance of a cured film, and it is preferable the isocyanate index is equal to or less than the upper limit of the above-mentioned range in terms of improving the processability of a cured film. From the viewpoint of further improving the balance of the water scale resistance and the chemical resistance as well as the processability of a cured film, the isocyanate index is preferably 0.6 to 1.4, more preferably 0.8 to 1.3, even more preferably 1.0 to 1.3, and particularly preferably 1.05 to 1.25.

1-4. Other Components

The coating agent composition of the present disclosure may further include other components, if necessary. Examples of the other components include active energy ray-curable resins, surface conditioners, photoinitiators, curing accelerators (curing catalysts, etc.), surfactants, ultraviolet absorbers, light stabilizers, dispersants, film-forming aids, antifoaming agents, viscosity regulators, and components for enhancing designability (for example, pigments and matting agents). These other components may be used singly, or two or more of them may be used in combination.

Examples of the surface conditioner include acrylic leveling agents, silicone leveling agents, fluorine leveling agents, and vinyl leveling agents. These surface conditioners may be used singly, or two or more of them may be used in combination.

Among these surface conditioners, silicone leveling agents are preferable from the viewpoint of improving the coating appearance (for example, improving leveling and suppressing cissing). Examples of the silicone leveling agent include BYK series manufactured by BYK Chemie, TEGO series manufactured by Evonik, and POLYFLOW series manufactured by Kyoeisha Chemical Co., Ltd.

When the coating agent composition of the present disclosure includes a surface conditioner, from the viewpoint of improving the appearance of a cured film, the content of the surface conditioner is, for example, 0.01 to 0.5 parts by mass, and preferably 0.05 to 0.3 parts by mass, per 100 parts by mass the components (A1), (A2) and (B).

1-5. Solvent

In the coating agent composition of the present disclosure, the above-described components are dissolved or dispersed in a solvent. Examples of the solvent include organic solvents. Examples of the organic solvent include aromatic hydrocarbon solvents such as toluene and xylene; alcohol solvents such as methanol, ethanol, isopropyl alcohol, n-butanol, isobutanol, tert-butanol (2-methyl-2-propanol), tert-amyl alcohol, diacetone alcohol; ketone solvents such as acetone, methyl ethyl ketone, methyl isobutyl ketone, and cyclohexanone; ester solvents such as ethyl acetate, propyl acetate, butyl acetate, and isobutyl acetate; among these, the aromatic hydrocarbon solvents, ketone solvents and ester solvents are preferable from the viewpoints of water scale resistance and stain resistance and from the viewpoint of being less likely to react with polyfunctional isocyanate compounds.

When the coating agent composition of the present disclosure contains a solvent, the content of the solvent is not particularly limited, but it may be such that the solid (nonvolatile components) concentration of the coating agent composition is, for example, 5 to 99% by mass, preferably 10 to 70% by mass, more preferably 20 to 60% by mass, and further preferably 30 to 50% by mass.

1-6. Form

The coating agent composition of the present disclosure is a material obtained by subjecting the component (A1), the component (A2) optionally blended, and the component (B) to a urethane reaction, thereby converting a urethane resin into a cured product. Therefore, the coating agent composition of the present disclosure is appropriately prepared in a form in which the urethane reaction is controlled. A specific form of the coating agent composition of the present disclosure may be either one-component type or two-component type.

The coating agent composition of the present disclosure in the case of a two-component type has been separated into a main agent composition including the component (A1) and the component (A2) optionally blended, and a curing agent composition including the component (B). The amount of the solvent to be used in the coating agent composition of the present disclosure in the case of a two-component type may be an amount that gives the above-mentioned solid concentration when the main agent composition and the curing agent composition are mixed.

Whereas, the coating agent composition of the present disclosure in the case of a one-component type is a mixture including the component (A1), the component (A2) optionally blended, and the component (B). In this case, from the viewpoint of storage stability (stability with time), it is preferable to use the component (B) in the form of a blocked isocyanate.

1-7. Physical Properties of Cured Film

As to a cured film of the coating agent composition of the present disclosure obtained by curing at 80° C. for 16 hours, the peak top temperature of the loss tangent (tan δ) of the cured film obtained by measuring viscoelasticity in the temperature range of −40 to 160° C. at a frequency of 1.0 Hz is, for example, 20 to 100° C., preferably 30 to 90° C., more preferably 40 to 80° C., and even more preferably 50 to 75° C. from the viewpoint of water scale resistance and chemical resistance. From the viewpoint of processability, the peak top temperature is, for example, 10 to 80° C., preferably 15 to 70° C., more preferably 20 to 60° C., and even more preferably 30 to 50° C. Furthermore, from the viewpoint of improving the balance between water scale resistance and chemical resistance and processability, the peak top temperature is, for example, 10 to 100° C., preferably 15 to 90° C., more preferably 20 to 80° C., even more preferably 30 to 70° C., and further preferably 40 to 60° C.

2. Laminated Film

The laminated film of the present disclosure is characterized by including a substrate layer having a prescribed elongation at break and a cured layer of the above-described coating agent composition laminated on the substrate layer and being to be used for protecting an exterior curved surface of a vehicle. The laminated film of the present disclosure can be used as a paint protection film (PPF).

The thickness of the laminated film of the present disclosure is, for example, 33 to 450 μm, preferably 53 to 300 μm, more preferably 103 to 230 μm, and further preferably 130 to 200 μm.

2-1. Exterior Curved Surface of Vehicle

The vehicle to which the laminated film of the present disclosure is to be attached is not particularly limited as long as it is a vehicle to be used outdoors, and examples thereof include automobiles, trucks, motorcycles, and trains.

The exterior curved surface that the laminated film of the present disclosure protects by being attached to a vehicle may be any curved surface of the vehicle that is exposed outdoors. Furthermore, the exterior curved surface is more preferably one coated with a coating film and/or a laminate for such a purpose as protection and/or decoration. Specific examples of the exterior curved surface of a vehicle include surfaces of three-dimensional articles such as exterior panels and exterior parts of vehicles, and more specifically, surfaces of bonnets, light frames, grills, bumpers, skirts, roofs, fenders, doors, handles, steps, mirrors, trunk lids, license plates, wheels, and mufflers.

2-2. Substrate Layer

The substrate layer is made of a material having an elongation at break of 100% or more. Since the cured layer of the above-described coating agent composition laminated on the substrate layer is superior in processability, a substrate layer having such a high elongation at break can be used, and it can render the laminated film of the present disclosure superior in processability. The elongation at break of the substrate layer is preferably 200% or more, more preferably 300% or more, and further preferably 400% or more. The upper limit of the range of the elongation at break of the substrate layer is not particularly limited, and it may be 800% or less, for example.

The elongation at break of the substrate layer can be obtained by measurement in accordance with JIS K7311 “Testing methods for thermoplastic polyurethane elastomers” tensile test. As to a test piece for the tensile test, a punching die for tensile test (tensile No. 3 type dumbbell shape) is used to make a dumbbell-shaped test piece having a parallel part length of 20 mm, a parallel part width of 5 mm, and a width of 25 mm at both ends (JIS K7311:1995 polyurethane-based thermoplastic elastomer Dumbbell-shaped test piece depicted in FIG. 2), and a dumbbell-shaped test piece on which marked lines for measuring elongation at break are drawn in the parallel part such that the marked line distance is 20 mm is prepared. The tensile test is conducted by performing tensile at a distance between grips of 70 mm, a marked line distance of 20 mm, a measuring temperature of 25° C. and a tensile speed of 300 mm/min using the prepared dumbbell-shaped test piece, and then measuring the marked line distance at break. The elongation at break of the substrate layer is the elongation ratio (%) of the test piece when the test piece breaks; specifically, the elongation at break is determined from the following formula where the initial length of the parallel part (marked line distance) is 20 (mm), the distance between the marked lines at break is x (mm).

Elongation at break (%)={(x−20)/20}×100

The material of the substrate layer is not particularly limited, and may be appropriately selected from the viewpoints of processability, durability, handleability, etc. Examples of the material of the substrate layer include thermoplastic resins such as polyester, polyurethane, polypropylene, polyvinyl chloride, triacetylcellulose, (meth)acrylic resin, polycarbonate, and thermoplastic polyimide. These thermoplastic resins may be used singly or two or more of them may be used in combination.

Among these materials, thermoplastic polyurethane is particularly preferable from the viewpoint of processability. Examples of the thermoplastic polyurethane include adipic acid-based thermoplastic polyurethane, polyether-based thermoplastic polyurethane, polycaprolactone-based thermoplastic polyurethane, polycarbonate-based thermoplastic polyurethane, acrylic-based thermoplastic polyurethane, phenolic resin-based thermoplastic polyurethane, epoxy-based thermoplastic polyurethane, butadiene-based thermoplastic polyurethane, and polyester-polyether-based thermoplastic polyurethane, and preferred are polyether-based thermoplastic polyurethane and polycarbonate-based thermoplastic polyurethane. Examples of commercially available thermoplastic polyurethanes include Miractolan series manufactured by Nippon Polyurethane Industry Co., Ltd. and PANDEX series manufactured by DIC Bayer Polymer Ltd.

In the production of a laminated film, a substrate film made of such a material can be used as the substrate layer.

The material of the substrate layer may be colorless and transparent, or may be colored from the viewpoint of designability, etc.

The thickness of the substrate layer is not particularly limited, and from the viewpoint of processability, durability, handleability, etc., it is, for example, 30 to 250 μm, preferably 50 to 200 μm, and more preferably 100 to 200 μm.

2-3. Cured Layer of Coating Agent Composition

The coating agent composition is as described in detail in “1. Coating agent composition” above.

A cured layer of a coating agent composition can be obtained by applying the above-described coating agent composition to a surface of a substrate film for constituting the above-mentioned substrate layer, and drying and curing it by a suitable method.

The method for applying the coating agent composition is not particularly limited, and it may be applied by using a known applicator such as bar coater, spray coater, air knife coater, kiss roll coater, metering bar coater, gravure roll coater, reverse roll coater, dip coater, and die coater.

The drying method is also not particularly limited, and a known drying technique for film coating may be appropriately applied.

The curing conditions may be appropriately set in consideration of the heat resistance, etc. of the material of the substrate layer. For example, the temperature condition is, for example, 40 to 120° C., preferably 60 to 100° C., and more preferably 70 to 90° C. Examples of the time condition is, for example, 1 minute to 24 hours. In the curing, it is possible to combine the baking for a short time in a higher temperature range of the above temperature condition and the baking for a longer time in the lower temperature range of the above temperature condition. The method of curing is not particularly limited as long as it is a method that can realize the above curing conditions, and examples thereof include a method that involves exposing to hot air and a method that involves using a drying oven (dryer) of a known coating machine.

The thickness of the cured layer of the coating agent composition is not particularly limited, and from the viewpoint of improving the balance between water scale resistance and chemical resistance and processability, it is, for example, 3 to 200 μm, preferably 3 to 100 μm, more preferably 3 to 30 μm, and further preferably 3 to 15 μm.

The dynamic viscoelasticity of the cured layer of the coating agent composition is as described in the above “1-7. Physical properties of cured film”, for example.

2-4. Other Layers

The laminated film of the present disclosure only needs to include at least a substrate layer and a cured layer of a coating agent composition, and may further include other layers in addition to the substrate layer and the cured layer of the coating agent composition. For example, an adhesive layer may be laminated on the side of the substrate layer opposite from the cured layer of the coating agent composition. Furthermore, a release sheet may be laminated on the cured layer of the coating agent composition to temporarily protect the surface thereof.

2-5. How to Use

The laminated film of the present disclosure is used by directing the substrate layer side to the vehicle exterior curved surface side, stretching it along the three-dimensional shape of the curved surface and deforming it, and sticking it with no gap between the curved surface. To be done. Since the laminated film of the present disclosure has superior processability due to the property that the cured layer of the coating agent composition is easily stretched, a beautiful finish on a vehicle after application can be easily obtained. Further, the laminated film of the present disclosure has a cured layer of a coating agent composition being superior in water scale resistance and chemical resistance, and therefore, in a vehicle in which the laminated film of the present disclosure is attached to an exterior curved surface, the exterior appearance thereof can be well protected from water scale-like stains and stains such as corrosion caused by chemicals.

### EXAMPLES

Hereinafter, the present invention will be described more specifically with reference to Examples and Comparative Examples, but the present invention is not limited thereto.

### Test Example 1

(1) Coating Agent Composition

(1-1) Raw Material

The raw materials shown in Tables 1 to 3 were prepared for the preparation of coating agent compositions.

TABLE 1
(A1) Raw materials for (meth)acrylic resin having hydroxyl group

| | | | Homopolymer | |
|---|---|---|---|---|
| | | | Tg (K) | Manufacturer |
| (a11) Alicyclic | BLEMMER | Cyclohexyl methacrylate | 339 | NOF |
| structure- | CHMA | | | |
| containing | LIGHT | Isobornyl methacrylate | 453 | Kyoeisha Chemical |
| (meth)acrylic | ESTER IB-X | | | |
| monomer | LIGHT | Isobornyl acrylate | 367 | Kyoeisha Chemical |
| | ACRYLATE | | | |
| | IB-XA | | | |
| | FANCRYL | Dicyclopentanyl methacrylate | 448 | Hitachi Chemical |
| | FA-513M | | | |
| (a12) Flexible | PLACCEL | Unsaturated fatty acid hydroxyalkyl ester | 233 | Daicel |
| structure- | FA2D | modified ε-caprolactone | | |
| containing | PLACCEL | Unsaturated fatty acid hydroxyalkyl ester | 220 | Daicel |
| (hydroxyl | FA5 | modified ε-caprolactone | | |
| group- | PLACCEL | Mixture of (3-hydroxy-2,2-dimethyl- | 283 | Daicel |
| containing) | HEMAC1 | propoxycarbonyloxy)-alkyl (meth)acrylate | | |
| (meth)acrylic | | and 2-hydroxyethyl methacrylate | | |
| monomer | BLEMMER | Polyethylene glycol monoacrylate | 219 | NOF |
| | AE-200 | | | |
| Others - | HEMA | 2-Hydroxyethyl methacrylate | 328 | |
| Hydroxyl | HEA | 2-Hydroxyethyl acrylate | 258 | |
| group- | 4HBA | 4-Hydroxybutyl acrylate | 233 | Mitsubishi Chemical |
| containing | | | | |
| (meth)acrylic | | | | |
| monomer | | | | |
| Others - | MMA | Methyl methacrylate | 378 | |
| (Meth)acrylic | BMA | n-Butyl methacrylate | 293 | |
| monomer | BA | n-Butyl acrylate | 219 | |
| | 2-EHA | 2-Ethylhexyl acrylate | 188 | |
| | MAA | Methacrylic acid | 501 | |
| Others - | Silaplane FM- | α-Butyl-ω-(3- | | JNC |
| Polysiloxane- | 0721 | methacryloxypropyl)polydimethylsiloxane | | |
| containing | | | | |
| (meth)acrylic | | | | |
| monomer | | | | |

TABLE 2
(A2) Polyol

| | | | | Hydroxyl | |
|---|---|---|---|---|---|
| | | | | value | |
| | | | Molecular | (KOH | |
| | | | weight | mg/g) | Manufacturer |
| Polycarbonate | ETERNACOLL ® | 1,4-Cyclohexane- | 900 | 125 | Ube Industries |
| | UM-90(l/l) | dimethanol:1,6- | | | |
| | | hexanediol = 50:50 | | | |
| Polycarbonate | DURANOL T5650E | 1,5-Pentanediol, | 500 | 224 | Asahi Kasei |
| | | 1,6-hexanediol | | | |
| Polycarbonate | DURANOL T5651 | 1,5-Pentanediol, | 1000 | 112 | Asahi Kasei |
| | | 1,6-hexanediol | | | |
| Polycarbonate | DURANOL T5652 | 1,5-Pentanediol, | 2000 | 56 | Asahi Kasei |
| | | 1,6-hexanediol | | | |
| Polycarbonate | DURANOL G3450J | 1,3-Propanediol, | 800 | 140 | Asahi Kasei |
| | | 1,4-butanediol | | | |
| Polycaprolactone | PLACCEL 205 | ε-Caprolactone | 550 | 212 | Daicel |
| Polycaprolactone | PLACCEL 303 | ε-Caprolactone | 310 | 540 | Daicel |
| Polycaprolactone | PLACCEL 305T | ε-Caprolactone | 550 | 306 | Daicel |
| Polycaprolactone | PLACCEL 410 | ε-Caprolactone | 1000 | 224 | Daicel |
| polyester | Kuraray polyol | MPD, isophthalic acid | 500 | 224 | Kuraray |
| | P-530 | | | | |
| Polyether | PTMG650 | Polytetramethylene | 650 | 173 | Mitsubishi |
| | | glycol | | | Chemical |

TABLE 3
(B) Polyfunctional isocyanate compound

| | | | Solid | | |
|---|---|---|---|---|---|
| | | | content | NCO % | |
| | | | (%) | (%) | Manufacturer |
| DURANATE TKA-100 | Hexamethylenediisocyanate | Nurate | 100 | 21.7 | Asahi Kasei |
| DURANATE 24A-100 | Hexamethylenediisocyanate | Biuret | 100 | 23.5 | Asahi Kasei |
| DURANATE P301-75E | Hexamethylenediisocyanate | Adduct | 75 | 12.5 | Asahi Kasei |
| TAKENATE D-131N | Xylylenediisocyanate | Nurate | 75 | 14 | Mitsui Chemicals |

Surface conditioner

| | | Solid content | |
|---|---|---|---|
| | | (%) | Manufacturer |
| BYK-302 | Polyether-modified | >95 | BYK-Chemie |
| | dimethylsiloxane | | |

(1-2) Synthesis of (Meth)Acrylic Resin Having a Hydroxyl Group (Component (A1)) (Synthesis Examples A1-1 to A1-25)

A four-necked flask equipped with a thermometer, a thermostat, a stirring device, a reflux condenser and a dropping device was prepared. This flask was charged with 100 parts by mass of isobutyl acetate, which was then heated to 115° C. with stirring. Then, a mixed liquid prepared by uniformly mixing the (meth)acrylic monomers with the ratio (in parts by mass) shown in Tables 4 to 11 and 2 parts by mass of 1,1-azobis-1-cyclohexanecarbonitrile (V-40 manufactured by Wako Pure Chemical Industries, Ltd.) as a polymerization initiator was continuously added dropwise from a dropping funnel to the above flask over 2 hours.

After the dropping was completed, the mixture was further stirred at 115° C. for 3 hours to react the residual monomer. Then, the heating was stopped and the mixture was cooled to room temperature to afford a resin composition (solid content ratio: 50% by mass) containing a (meth)acrylic resin having a hydroxyl group as the component (A1).

The number average molecular weight (Mn) and the weight average molecular weight (Mw) of the obtained component (A1) were measured and calculated by gel permeation chromatography (GPC) using the following devices and conditions.
Device used: HLC8220GPC (manufactured by Tosoh Corporation)
Columns used: TSKgel Super HZM-M, TSKgel GMHXL-H, TSKgel G2500HXL, and TSKgel G5000HXL (manufactured by Tosoh Corporation)
Column temperature: 40° C.
Standard substance: TSKgel standard polystyrene A1000, A2500, A5000, F1, F2, F4, F10 (manufactured by Tosoh Corporation)
Detector: RI (differential refraction) detector
Eluent: Tetrahydrofuran
Flow rate: 1 ml/min

Further, for each of the components (A1) obtained in Synthesis Examples A1-1 to A1-25, the glass transition temperature of the component (A1) was theoretically calculated from the blending ratio of the monomers used, on the basis of the above-mentioned Fox's formula.

(1-3) Preparation of Coating Agent Composition

Coating agent compositions with a solid content ratio of 40% by mass were obtained by mixing each of the components (A1) obtained in Synthesis Examples A1-1 to A1-25, a component (B) with the ratio (in parts by mass) shown in Tables 4 to 11, and optionally a component (A2) and a leveling agent, and further adding methyl ethyl ketone.

(1-4) Measurement of Hydroxyl Value

The hydroxyl value (“OH value” in Tables 4 to 11) of each of the components (A1) and the components (A2) was determined. Furthermore, when the coating agent composition contains a component (A2), the total hydroxyl value of the component (A1) and the component (A2) (the hydroxyl value of a uniform mixture of the component (A1) and the component (A2) with the ratio (in parts by mass) shown in Tables 4 to 11); “total OH value (A1+A2)” in the tables) was also determined. Specifically, hydroxyl values were determined in accordance with the method specified in “7.1 Neutralization titration method” contained in JIS K 0070 “Test methods for acid value, saponification value, ester value, iodine value, hydroxyl value and unsaponifiable matter of chemical products”. An acid value is also required for the calculation of a hydroxyl value, and the acid value was also determined in accordance with the method specified in “3.1 Neutralization titration method” of that JIS standard.

(2) Cured Film of Coating Agent Composition

The coating agent composition prepared in (1) above was applied to the surface of a polypropylene plate (10 mm in length, 10 mm in width, and 2 mm in thickness, made in accordance with JIS-K6921) using a 10 mil applicator, and then was allowed to stand at room temperature for 10 minutes. Then, it was cured with a warm air dryer at 80° C. for 16 hours. Then, it was left to cool at room temperature for 1 hour. As a result, a cured film having a thickness of 60 μm was obtained.

The cured film was peeled off from the polypropylene plate and cut into a test piece having a width of 5 mm and a length of 50 mm Using this test piece, the peak top temperature of loss tangent (tan δ) was measured under the following conditions.
Device: Dynamic viscoelasticity analyzer RSA-G2 (manufactured by TA Instruments)
Measurement mode: Non-resonant forced vibration method
Heating rate: 5.0° C./min
Measurement interval: 12/min
Frequency: 1.0 Hz
Temperature range: −40 to 160° C.

(2) Laminated Film

(2-1) Preparation of Laminated Film

The coating agent composition prepared in (1) above was applied to a thermoplastic polyurethane film TPU having a thickness of 150 μm, a length of 100 mm and a width of 100 mm with a No. 18 bar coater and cured at 80° C. and 16 hours, and then, it was allowed to stand at room temperature for 1 hour. In this way, a laminated film in which a cured layer of the coating agent composition was laminated on the thermoplastic polyurethane substrate layer was obtained. The thickness (μm) of the cured layer is as shown in Tables 4 to 11.

The elongation at break of the thermoplastic polyurethane film used for the substrate layer was 500%. The elongation at break of the thermoplastic polyurethane film used for the substrate layer was obtained by measurement in accordance with JIS K7311 “Testing methods for thermoplastic polyurethane elastomers” tensile test. As to the test piece for the tensile test, a punching die for tensile test (tensile No. 3 type dumbbell shape) was used to make a dumbbell-shaped test piece having a parallel part length of 20 mm, a parallel part width of 5 mm, and a width of 25 mm at both ends (JIS K7311:1995 polyurethane-based thermoplastic elastomer Dumbbell-shaped test piece depicted in FIG. 2), and a dumbbell-shaped test piece on which marked lines for measuring elongation at break were drawn in the parallel part such that the marked line distance was 20 mm was prepared. The tensile test was conducted by performing tensile at a distance between grips of 70 mm, a marked line distance of 20 mm, a measuring temperature of 25° C. and a tensile speed of 300 mm/min using the prepared dumbbell-shaped test piece, and then measuring the marked line distance at break. The elongation at break of the substrate layer is the elongation rate (%) of the test piece when the test piece breaks, specifically, the length of the initial parallel part (mark line distance) is 20 (mm), the distance between the marked lines at break was x (mm), and the elongation at break (%) was calculated by the following formula.

Elongation at break (%)={(x−20)/20}×100

(2-2) Performance Evaluation of Laminated Film

The obtained laminated film was subjected to the following performance evaluation. The results of each performance evaluation are shown in Tables 4 to 11.

(2-2-1) Processability

The laminated film was cut into a strip-shaped test piece having a width of 10 mm and a length of 80 mm Both short sides of the test piece were gripped with the upper and lower chucks of the tester, and the film was placed such that the distance between the chucks was 50 mm. The upper chuck was moved upwards at a speed of 100 mm/min at a room temperature of 25° C., and the elongation at break (%) of the cured film was calculated on the basis of the following formula from the distance traveled upward (x mm) when a crack occurred on the cured film surface of the test piece (when the cured film broke) and the initial distance between the chucks (50 mm).

Elongation at break of laminated film (%)=(x/50)×100

(2-2-2) Water Scale Resistance

A laminated film was attached to the surface of a black acrylonitrile butadiene styrene (ABS) plate, and the resultant item was leveled with the cured layer being on the top and then was allowed to stand outdoors for two months. The site where the item was left standing was Mizuho-ku, Nagoya City, and the installation time was from April to June, 2019. After being left standing, the surface of the cured layer was washed with water and water droplets were wiped off, and the surface was visually observed to examine stains that looked like scales (water scale-like stains), and the water scale resistance was evaluated on the basis of the following criteria.

5: There was no water scale-like stain.

4: A small amount of water scale-like stain were partially generated.

3: A small amount of water scale-like stain were generated overall.

2: A small amount of water scale-like stain was generated overall, and there were some noticeable parts.

1: Water scale-like stain was noticeable overall.

(2-2-3) Chemical Resistance

A laminated film was attached to the surface of a black acrylonitrile butadiene styrene (ABS) plate, and the 0.05 ml of dichloromethane was dropped to the surface of the cured layer under an atmosphere having a temperature of 25° C. and a relative humidity of 60 RH %. After being allowed to stand for 10 seconds, dichloromethane was wiped off with a tissue paper and the surface state of the cured layer was visually observed, and then chemical resistance was evaluated on the basis of the following criteria.

5: After wiping off, no mark was left.

4: After wiping off, the part that had been in contact with dichloromethane was slightly swollen.

3: After wiping off, the part that had been in contact with dichloromethane was swollen.

2: After wiping off, the part that had been in contact with dichloromethane was slightly whitened.

1: After wiping off, the part that had been in contact with dichloromethane was whitened.

(2-2-4) Coating Appearance

The cured film surface of a laminated film was visually observed, and the appearance was evaluated on the basis of the following criteria.

◯: There was no appearance defect and a smooth coated surface was obtained.

Δ: Poor leveling and cissing were partially observed.

x: Poor leveling and cissing were observed overall.

(2-2-5) Scratch Resistance (Self-Healing Property)

A brass brush (3 rows of wooden pattern brass brushes) was attached to the cured film surface of a laminated film in an atmosphere having a temperature of 25° C. and a relative humidity of 60 RH %, and the surface was scratched by reciprocating the brash 10 times with a load of 500 g. Then, the laminated film was exposed at a relative humidity of 60 RH % to the following conditions: at room temperature (25° C.) for 24 hours, at 60° C. for 24 hours, at 70° C. for 24 hours, and at 80° C. for 24 hours in order, and the healing of scratches was visually observed and the scratch resistance (self-healing property) was evaluated according to the following criteria.

5: Scratches were healed within 24 hours at room temperature.

4: Scratches were not healed at room temperature, but were healed within 24 hours in the 60° C. atmosphere.

3: Scratches were not healed in the 60° C. atmosphere, but were healed within 24 hours in the 70° C. atmosphere.

2: Scratches were not healed in the 70° C. atmosphere, but were healed within 24 hours in the 80° C. atmosphere.

1: Scratches were not healed in the 80° C. atmosphere.

(2-2-6) Resistance to Felt Pen Ink Stains

A line of 5 cm long was drawn on the cured film surface of a laminated film with Magic INK Black (manufactured by Teranishi Chemical Industry Co., Ltd.) at a temperature of 25° C. and a relative humidity of 60 RH %, and allowed to stand for 5 minutes. Then, the line drawn was wiped off with tissue soaked with isopropyl alcohol. The surface of the cured film of the laminated film after being wiped off was visually observed, and the resistance to felt pen ink stains was evaluated according to the following criteria.

4: No colored marks remained.

3: Colored marks remained thin.

2: Colored marks remained dark.

1: The drawn line could not be wiped off at all.

TABLE 4

| | | | | Examples | | | | | | | |
|---|---|---|---|---|---|---|---|---|---|---|---|
| | | | | 1 | 2 | 3 | 4 | 5 | 6 | 7 | 8 |
| Cured | (A1) Synthesis Example | | | A1-1 | A1-2 | A1-3 | A1-4 | A1-5 | A1-6 | A1-7 | A1-8 |
| layer of | | (a11) Alicyclic | CHMA | 30.0 | 50.0 | 70.0 | 50.0 | 25.0 | — | — | — |
| coating | | structure- | IB-X | — | — | — | — | 25.0 | 50.0 | — | — |
| agent | | containing | IB-XA | — | — | — | — | — | — | 50.0 | — |
| composi- | | monomer | FA-513M | — | — | — | — | — | — | — | 50.0 |
| tion | (A1) OH- | (a12) Flexible | FA2D | 10.0 | 10.0 | 10.0 | 20.0 | 15.0 | 15.0 | 20.0 | 15.0 |
| | containing | structure (OH)- | FA5 | 5.0 | 5.0 | 5.0 | 15.0 | 20.0 | 20.0 | 15.0 | 20.0 |
| | (meth)acrylate | containing | HEMAC1 | — | — | — | — | — | — | — | — |
| | resin | monomer | AE-200 | — | — | — | — | — | — | — | — |
| | | Other OH- | HEMA | 10.0 | 10.0 | — | 10.0 | 10.0 | 10.0 | 10.0 | 10.0 |
| | | containing | HEA | — | — | 10.0 | — | — | — | — | — |
| | | monomers | 4HBA | — | — | — | — | — | — | — | — |
| | | | MMA | 25.0 | 15.0 | — | — | — | — | 5.0 | — |
| | | | BMA | 15.0 | 5.0 | — | — | — | — | — | — |
| | | | BA | 5.0 | 5.0 | 5.0 | 5.0 | 5.0 | 5.0 | — | 5.0 |
| | | | 2-EHA | — | — | — | — | — | — | — | — |
| | | | MAA | — | — | — | — | — | — | — | — |
| | | PDMS monomer | FM-0721 | — | — | — | — | — | — | — | — |
| | | OH value (KOH mg/g) | | 63.6 | 63.6 | 68.8 | 88.0 | 84.0 | 89.2 | 88.0 | 89.2 |
| | | Glass transition temperature (° C.) | | 34.9 | 36.4 | 26.6 | 8.8 | 23.3 | 40.5 | 26.4 | 39.3 |
| | | Number average molecular weight | | 6.0 | 5.8 | 5.5 | 5.7 | 5.5 | 5.0 | 6.2 | 5.2 |
| | | (×1000) | | | | | | | | | |
| | | Weight average molecular weight | | 30.0 | 28.0 | 28.0 | 24.0 | 20.0 | 21.0 | 22.0 | 19.0 |
| | | (×1000) | | | | | | | | | |
| | (A2) | Polycarbonate | T5650E | — | — | — | — | — | — | — | — |
| | Polyol | | G3450J | — | — | — | — | — | — | — | — |
| | | | UM-90 | — | — | — | — | — | — | — | — |
| | | polyester | P-530 | — | — | — | — | — | — | — | — |
| | | Polycaprolactone | PLACCEL | — | — | — | — | — | — | — | — |
| | | | 205 | | | | | | | | |
| | | | PLACCEL | — | — | — | — | — | — | — | — |
| | | | 305T | | | | | | | | |
| | | | PLACCEL | — | — | — | — | — | — | — | — |
| | | | 410 | | | | | | | | |
| | | Polyether | PTMG650 | — | — | — | — | — | — | — | — |
| | | OH value | KOH mg/g | — | — | — | — | — | — | — | — |
| | Total OH value (A1 + A2) | | KOH mg/g | 63.6 | 63.6 | 68.8 | 88.0 | 84.0 | 89.2 | 88.0 | 89.2 |
| | (B) Poly- | Polyfunctional | TKA-100 | 24.1 | 24.1 | 26.1 | 33.3 | 31.9 | 33.9 | 33.3 | 33.9 |
| | functional | isocyanates | 24A-100 | — | — | — | — | — | — | — | — |
| | isocyanate | | P301-75E | — | — | — | — | — | — | — | — |
| | compound | | D-131N | — | — | — | — | — | — | — | — |
| | | NCO % | % | 21.7 | 21.7 | 21.7 | 21.7 | 21.7 | 21.7 | 21.7 | 21.7 |

| | | | | | | | | |
|---|---|---|---|---|---|---|---|---|
| Isocyanate index | 1.1 | 1.1 | 1.1 | 1.1 | 1.1 | 1.1 | 1.1 | 1.1 |

| | Surface conditioner | BYK-302 | — | — | — | — | — | — | — | — |
|---|---|---|---|---|---|---|---|---|---|---|
| | tanδ Peak top temperature (° C.) | | 75 | 78 | 72 | 62 | 65 | 72 | 56 | 68 |
| Laminated | Cured layer thickness (μm) | | 10 | 10 | 10 | 10 | 10 | 10 | 10 | 10 |
| film | Substrate layer | Type | TPU | TPU | TPU | TPU | TPU | TPU | TPU | TPU |
| | | Thickness (μm) | 150 | 150 | 150 | 150 | 150 | 150 | 150 | 150 |

| | | | | | | | | | |
|---|---|---|---|---|---|---|---|---|---|
| Evaluation | Processability (elongation at break (%)) | 130 | 124 | 120 | 116 | 112 | 112 | 122 | 118 |
| | Water scale resistance | 3 | 4 | 4 | 4 | 5 | 5 | 4 | 5 |
| | Chemical resistance | 3 | 4 | 4 | 4 | 4 | 5 | 4 | 4 |
| | Coating appearance | Δ | Δ | Δ | Δ | Δ | Δ | Δ | Δ |
| | Scratch resistance | 2 | 2 | 2 | 3 | 3 | 3 | 3 | 3 |
| | Resistance to felt pen ink stains | 4 | 4 | 4 | 4 | 4 | 4 | 3 | 4 |

TABLE 5

| | | | | Examples | | | | | | | |
|---|---|---|---|---|---|---|---|---|---|---|---|
| | | | | 9 | 10 | 11 | 12 | 13 | 5 | 14 | 15 |
| Cured | (A1) Synthesis Example | | | A1-9 | A1-10 | A1-11 | A1-12 | A1-13 | A1-5 | A1-14 | A1-15 |
| layer of | | (a11) Alicyclic | CHMA | 25.0 | 25.0 | 25.0 | 25.0 | 25.0 | 25.0 | 25.0 | 25.0 |
| coating | | structure- | IB-X | 25.0 | 25.0 | — | — | 25.0 | 25.0 | — | — |
| agent | | containing | IB-XA | — | — | 25.0 | 25.0 | — | — | 25.0 | 25.0 |
| composi- | | monomer | FA-513M | — | — | — | — | — | — | — | — |
| tion | (A1) OH- | (a12) Flexible | FA2D | 25.0 | — | — | — | 15.0 | 15.0 | 20.0 | 25.0 |
| | containing | structure (OH)- | FA5 | — | 40.0 | — | — | 20.0 | 20.0 | 10.0 | — |
| | (meth)acrylate | containing | HEMAC1 | — | — | 20.0 | — | — | — | — | — |
| | resin | monomer | AE-200 | — | — | — | 25.0 | — | — | — | — |
| | | Other OH- | HEMA | 10.0 | 10.0 | 10.0 | 10.0 | 6.0 | 10.0 | 15.0 | 20.0 |
| | | containing | HEA | — | — | — | — | — | — | — | — |
| | | monomers | 4HBA | — | — | — | — | — | — | — | — |
| | | | MMA | — | — | — | 10.0 | — | — | — | — |
| | | | BMA | — | — | — | — | — | — | — | — |
| | | | BA | 15.0 | — | 10.0 | 5.0 | 9.0 | 5.0 | 5.0 | — |
| | | | 2-EHA | — | — | 10.0 | — | — | — | — | 5.0 |
| | | | MAA | — | — | — | — | — | — | — | — |
| | | PDMS monomer | FM-0721 | — | — | — | — | — | — | — | — |
| | | OH value (KOH mg/g) | | 83.9 | 75.9 | 86.3 | 84.4 | 66.7 | 84.0 | 105.5 | 127.1 |
| | | Glass transition temperature (° C.) | | 25.3 | 20.0 | 19.4 | 24.8 | 18.0 | 23.3 | 19.6 | 24.0 |
| | | Number average molecular weight | | 5.6 | 5.8 | 5.2 | 5.2 | 5.8 | 5.5 | 5.6 | 6.1 |
| | | (×1000) | | | | | | | | | |
| | | Weight average molecular weight | | 28.0 | 30.0 | 24.0 | 26.0 | 30.0 | 20.0 | 24.0 | 22.0 |
| | | (×1000) | | | | | | | | | |
| | (A2) | Polycarbonate | T5650E | — | — | — | — | — | — | — | — |
| | Polyol | | G3450J | — | — | — | — | — | — | — | — |
| | | | UM-90 | — | — | — | — | — | — | — | — |
| | | polyester | P-530 | — | — | — | — | — | — | — | — |
| | | Polycaprolactone | PLACCEL | — | — | — | — | — | — | — | — |
| | | | 205 | | | | | | | | |
| | | | PLACCEL | — | — | — | — | — | — | — | — |
| | | | 305T | | | | | | | | |
| | | | PLACCEL | — | — | — | — | — | — | — | — |
| | | | 410 | | | | | | | | |
| | | Polyether | PTMG650 | — | — | — | — | — | — | — | — |
| | | OH value | KOH mg/g | — | — | — | — | — | — | — | — |
| | Total OH value (A1 + A2) | | KOH mg/g | 84.0 | 76.0 | 86.3 | 84.4 | 66.7 | 84.0 | 105.5 | 127.1 |
| | (B) Poly- | Polyfunctional | TKA-100 | 31.9 | 28.9 | 32.8 | 32.1 | 25.3 | 31.9 | 40.1 | 48.1 |
| | functional | isocyanates | 24A-100 | — | — | — | — | — | — | — | — |
| | isocyanate | | P301-75E | — | — | — | — | — | — | — | — |
| | compound | | D-131N | — | — | — | — | — | — | — | — |
| | | NCO % | % | 21.7 | 21.7 | 21.7 | 21.7 | 21.7 | 21.7 | 21.7 | 21.7 |

| | | | | | | | | |
|---|---|---|---|---|---|---|---|---|
| Isocyanate index | 1.1 | 1.1 | 1.1 | 1.1 | 1.1 | 1.1 | 1.1 | 1.1 |

| | Surface conditioner | BYK-302 | — | — | — | — | — | — | — | — |
|---|---|---|---|---|---|---|---|---|---|---|
| | tanδ Peak top temperature (° C.) | | 64 | 57 | 58 | 62 | 53 | 65 | 66 | 78 |
| Laminated | Cured layer thickness (μm) | | 10 | 10 | 10 | 10 | 10 | 10 | 10 | 10 |
| film | Substrate layer | Type | TPU | TPU | TPU | TPU | TPU | TPU | TPU | TPU |
| | | Thickness (μm) | 150 | 150 | 150 | 150 | 150 | 150 | 150 | 150 |

| | | | | | | | | | |
|---|---|---|---|---|---|---|---|---|---|
| Evaluation | Processability (elongation at break (%)) | 106 | 120 | 88 | 114 | 128 | 112 | 94 | 70 |
| | Water scale resistance | 4 | 4 | 5 | 3 | 3 | 5 | 5 | 5 |
| | Chemical resistance | 4 | 4 | 4 | 4 | 3 | 4 | 5 | 5 |
| | Coating appearance | Δ | Δ | Δ | Δ | Δ | Δ | Δ | Δ |
| | Scratch resistance | 3 | 3 | 3 | 3 | 4 | 3 | 3 | 2 |
| | Resistance to felt pen ink stains | 3 | 3 | 3 | 3 | 3 | 4 | 4 | 4 |

TABLE 6

| | | | | Examples | | | | | | | | |
|---|---|---|---|---|---|---|---|---|---|---|---|---|
| | | | | 7 | 16 | 17 | 18 | 19 | 20 | 2 | 21 | 22 |
| Cured | (A1) Synthesis Example | | | A1-7 | A1-16 | A1-17 | A1-18 | A1-4 | A1-4 | A1-2 | A1-2 | A1-2 |
| layer of | | (a11) Alicyclic | CHMA | — | — | — | — | 50.0 | 50.0 | 50.0 | 50.0 | 50.0 |
| coating | | structure- | IB-X | — | — | — | 45.0 | — | — | — | — | — |
| agent | | containing | IB-XA | 45.0 | 44.0 | 45.0 | — | — | — | — | — | — |
| composi- | | monomer | FA-513M | — | — | — | — | — | — | — | — | — |
| tion | (A1) OH- | (a12) Flexible | FA2D | 20.0 | 20.0 | 20.0 | 50.0 | 20.0 | 20.0 | 10.0 | 10.0 | 10.0 |
| | containing | structure (OH)- | FA5 | 15.0 | 15.0 | 15.0 | — | 15.0 | 15.0 | 5.0 | 5.0 | 5.0 |
| | (meth)acrylate | containing | HEMAC1 | — | — | — | — | — | — | — | — | — |
| | resin | monomer | AE-200 | — | — | — | — | — | — | — | — | — |
| | | Other OH- | HEMA | 10.0 | 10.0 | 10.0 | — | 10.0 | 10.0 | 10.0 | 10.0 | 10.0 |
| | | containing | HEA | — | — | — | | — | — | — | — | — |
| | | monomers | 4HBA | — | — | — | | — | — | — | — | — |
| | | | MMA | 10.0 | 10.0 | 5.0 | 5.0 | — | — | 15.0 | 15.0 | 15.0 |
| | | | BMA | — | — | — | — | — | — | 5.0 | 5.0 | 5.0 |
| | | | BA | — | — | — | — | 5.0 | 5.0 | 5.0 | 5.0 | 5.0 |
| | | | 2-EHA | — | — | — | — | — | — | — | — | — |
| | | | MAA | — | 1.0 | — | — | — | — | — | — | — |
| | | PDMS monomer | FM-0721 | — | — | 5.0 | — | — | — | — | — | — |
| | | OH value (KOH mg/g) | | 88.0 | 88.0 | 88.0 | 81.5 | 88.0 | 88.0 | 63.6 | 63.6 | 63.6 |
| | | Glass transition temperature (° C.) | | 26.8 | 27.4 | 23.6 | 32.7 | 8.8 | 8.8 | 36.4 | 36.4 | 36.4 |
| | | Number average molecular weight | | 6.2 | 6.0 | 6.2 | 5.0 | 5.7 | 5.7 | 5.8 | 5.8 | 5.8 |
| | | (×1000) | | | | | | | | | | |
| | | Weight average molecular weight | | 22.0 | 22.0 | 22.0 | 20.0 | 24.0 | 24.0 | 28.0 | 28.0 | 28.0 |
| | | (×1000) | | | | | | | | | | |
| | (A2) | Polycarbonate | T5650E | — | — | — | — | 100.0 | 100.0 | — | — | 100.0 |
| | Polyol | | T5651 | — | — | — | — | — | — | — | 100.0 | — |
| | | | G3450J | — | — | — | — | — | — | — | — | — |
| | | | UM-90 | — | — | — | — | — | — | — | — | — |
| | | polyester | P-530 | — | — | — | — | — | — | — | — | — |
| | | Polycaprolactone | PLACCEL | — | — | — | — | — | — | — | — | — |
| | | | 205 | | | | | | | | | |
| | | | PLACCEL | — | — | — | — | — | — | — | — | — |
| | | | 305T | | | | | | | | | |
| | | | PLACCEL | — | — | — | — | — | — | — | — | — |
| | | | 410 | | | | | | | | | |
| | | Polyether | PTMG650 | — | — | — | — | — | — | — | — | — |
| | | OH value | KOH mg/g | — | — | — | — | 224.0 | 224.0 | — | 112.0 | 224.0 |
| | Total OH value (A1 + A2) | | KOH mg/g | 88.0 | 88.0 | 88.0 | 81.5 | 156.0 | 156.0 | 63.6 | 87.8 | 143.8 |
| | (B) Poly- | Polyfunctional | TKA-100 | 33.3 | 33.3 | 33.3 | 30.9 | 118.5 | 118.5 | 24.1 | 66.7 | 109.1 |
| | functional | isocyanates | 24A-100 | — | — | — | — | — | — | — | — | — |
| | isocyanate | | P301-75E | — | — | — | — | — | — | — | — | — |
| | compound | | D-131N | — | — | — | — | — | — | — | — | — |
| | | NCO % | % | 21.7 | 21.7 | 21.7 | 21.7 | 21.7 | 21.7 | 21.7 | 21.7 | 21.7 |

| | | | | | | | | | |
|---|---|---|---|---|---|---|---|---|---|
| Isocyanate index | 1.1 | 1.1 | 1.1 | 1.1 | 1.1 | 1.1 | 1.1 | 1.1 | 1.1 |

| | Surface conditioner | BYK-302 | — | — | — | — | — | 0.6 | — | — | — |
|---|---|---|---|---|---|---|---|---|---|---|---|
| | tanδ Peak top temperature (° C.) | | 56 | 58 | 54 | 62 | 35 | 35 | 78 | 33 | 40 |
| Laminated | Cured layer thickness (μm) | | 10 | 10 | 10 | 10 | 10 | 10 | 10 | 10 | 10 |
| film | Substrate layer | Type | TPU | TPU | TPU | TPU | TPU | TPU | TPU | TPU | TPU |
| | | Thickness (μm) | 150 | 150 | 150 | 150 | 150 | 150 | 150 | 150 | 150 |

| | | | | | | | | | | |
|---|---|---|---|---|---|---|---|---|---|---|
| Evaluation | Processability (elongation at break (%)) | 122 | 122 | 114 | 120 | 144 | 144 | 124 | 210 | 140 |
| | Water scale resistance | 4 | 4 | 4 | 4 | 4 | 4 | 4 | 3 | 3 |
| | Chemical resistance | 4 | 4 | 4 | 4 | 4 | 4 | 4 | 3 | 4 |
| | Coating appearance | Δ | Δ | ◯ | Δ | Δ | ◯ | Δ | Δ | Δ |
| | Scratch resistance | 3 | 3 | 4 | 3 | 5 | 5 | 2 | 5 | 5 |
| | Resistance to felt pen ink stains | 3 | 3 | 4 | 4 | 3 | 3 | 4 | 3 | 3 |

TABLE 7

| | | | | Examples | | | | | | | | |
|---|---|---|---|---|---|---|---|---|---|---|---|---|
| | | | | 14 | 23 | 24 | 25 | 26 | 27 | 28 | 29 | 30 |
| Cured | (A1) Synthesis Example | | | A1-14 | A1-14 | A1-14 | A1-14 | A1-14 | A1-14 | A1-14 | A1-14 | A1-14 |
| layer of | | (a11) Alicyclic | CHMA | 25.0 | 25.0 | 25.0 | 25.0 | 25.0 | 25.0 | 25.0 | 25.0 | 25.0 |
| coating | | structure- | IB-X | — | — | — | — | — | — | — | — | — |
| agent | | containing | IB-XA | 25.0 | 25.0 | 25.0 | 25.0 | 25.0 | 25.0 | 25.0 | 25.0 | 25.0 |
| composi- | | monomer | FA-513M | — | — | — | — | — | — | — | — | — |
| tion | (A1) OH- | (a12) Flexible | FA2D | 20.0 | 20.0 | 20.0 | 20.0 | 20.0 | 20.0 | 20.0 | 20.0 | 20.0 |
| | containing | structure (OH)- | FA5 | 10.0 | 10.0 | 10.0 | 10.0 | 10.0 | 10.0 | 10.0 | 10.0 | 10.0 |
| | (meth)acrylate | containing | HEMAC1 | — | — | — | — | — | — | — | — | — |
| | resin | monomer | AE-200 | — | — | — | — | — | — | — | — | — |
| | | Other OH- | HEMA | 15.0 | 15.0 | 15.0 | 15.0 | 15.0 | 15.0 | 15.0 | 15.0 | 15.0 |
| | | containing | HEA | — | — | — | — | — | — | — | — | — |
| | | monomers | 4HBA | — | — | — | — | — | — | — | — | — |
| | | | MMA | — | — | — | — | — | — | — | — | — |
| | | | BMA | — | — | — | — | — | — | — | — | — |
| | | | BA | 5.0 | 5.0 | 5.0 | 5.0 | 5.0 | 5.0 | 5.0 | 5.0 | 5.0 |
| | | | 2-EHA | — | — | — | — | — | — | — | — | — |
| | | | MAA | — | — | — | — | — | — | — | — | — |
| | | PDMS monomer | FM-0721 | — | — | — | — | — | — | — | — | — |
| | | OH value (KOH mg/g) | | 105.5 | 105.5 | 105.5 | 105.5 | 105.5 | 105.5 | 105.5 | 105.5 | 105.5 |
| | | Glass transition temperature (° C.) | | 19.6 | 19.6 | 19.6 | 19.6 | 19.6 | 19.6 | 19.6 | 19.6 | 19.6 |
| | | Number average molecular weight | | 5.6 | 5.6 | 5.6 | 5.6 | 5.6 | 5.6 | 5.6 | 5.6 | 5.6 |
| | | (×1000) | | | | | | | | | | |
| | | Weight average molecular weight | | 24.0 | 24.0 | 24.0 | 24.0 | 24.0 | 24.0 | 24.0 | 24.0 | 24.0 |
| | | (×1000) | | | | | | | | | | |
| | (A2) | Polycarbonate | T5650E | — | — | — | — | — | — | — | — | — |
| | Polyol | | G3450J | — | 100.0 | — | — | — | — | — | — | — |
| | | | UM-90 | — | — | 100.0 | — | — | — | — | — | — |
| | | polyester | P-530 | — | — | — | 100.0 | — | — | — | — | — |
| | | Polycaprolactone | PLACCEL | — | — | — | — | 100.0 | — | — | — | — |
| | | | 205 | | | | | | | | | |
| | | | PLACCEL | — | — | — | — | — | 100.0 | — | — | — |
| | | | 303 | | | | | | | | | |
| | | | PLACCEL | — | — | — | — | — | — | 100.0 | — | — |
| | | | 305T | | | | | | | | | |
| | | | PLACCEL | — | — | — | — | — | — | — | 100.0 | — |
| | | | 410 | | | | | | | | | |
| | | Polyether | PTMG650 | — | — | — | — | — | — | — | — | 100.0 |
| | | OH value | KOH mg/g | | 140.0 | 125.0 | 224.0 | 212.0 | 540.0 | 306.0 | 224.0 | 173.0 |
| | Total OH value (A1 + A2) | | KOH mg/g | 105.5 | 122.8 | 115.3 | 164.8 | 158.8 | 322.8 | 205.8 | 164.8 | 139.3 |
| | (B) Poly- | Polyfunctional | TKA-100 | 40.1 | 93.3 | 87.4 | 125.2 | 120.5 | 245.4 | 156.5 | 125.2 | 105.8 |
| | functional | isocyanates | 24A-100 | — | — | — | — | — | — | — | — | — |
| | isocyanate | | P301-75E | — | — | — | — | — | — | — | — | — |
| | compound | | D-131N | — | — | — | — | — | — | — | — | — |
| | | NCO % | % | 21.7 | 21.7 | 21.7 | 21.7 | 21.7 | 21.7 | 21.7 | 21.7 | 21.7 |

| | | | | | | | | | |
|---|---|---|---|---|---|---|---|---|---|
| Isocyanate index | 1.1 | 1.1 | 1.1 | 1.1 | 1.1 | 1.1 | 1.1 | 1.1 | 1.1 |

| | Surface conditioner | BYK-302 | — | — | — | — | — | — | — | — | — |
|---|---|---|---|---|---|---|---|---|---|---|---|
| | tanδ Peak top temperature (° C.) | | 66 | 40 | 46 | 52 | 32 | 72 | 51 | 42 | 20 |
| Laminated | Cured layer thickness (μm) | | 10 | 10 | 10 | 10 | 10 | 10 | 10 | 10 | 10 |
| film | Substrate layer | Type | TPU | TPU | TPU | TPU | TPU | TPU | TPU | TPU | TPU |
| | | Thickness (μm) | 150 | 150 | 150 | 150 | 150 | 150 | 150 | 150 | 150 |

| | | | | | | | | | | |
|---|---|---|---|---|---|---|---|---|---|---|
| Evaluation | Processability (elongation at break (%)) | 94 | 116 | 112 | 120 | 124 | 80 | 100 | 104 | 122 |
| | Water scale resistance | 5 | 4 | 4 | 5 | 3 | 5 | 4 | 4 | 3 |
| | Chemical resistance | 5 | 4 | 4 | 4 | 4 | 5 | 5 | 4 | 3 |
| | Coating appearance | Δ | Δ | Δ | Δ | Δ | Δ | Δ | Δ | Δ |
| | Scratch resistance | 3 | 5 | 5 | 4 | 5 | 2 | 4 | 5 | 5 |
| | Resistance to felt pen ink stains | 4 | 3 | 3 | 3 | 2 | 4 | 3 | 3 | 2 |

TABLE 8

| | | | | Examples | | | | | |
|---|---|---|---|---|---|---|---|---|---|
| | | | | 4 | 31 | 32 | 33 | 19 | 34 |
| Cured | (A1) Synthesis Example | | | A1-4 | A1-4 | A1-4 | A1-4 | A1-4 | A1-4 |
| layer of | | (a11) Alicyclic | CHMA | 50.0 | 50.0 | 50.0 | 50.0 | 50.0 | 50.0 |
| coating | | structure- | IB-X | — | — | — | — | — | — |
| agent | | containing | IB-XA | — | — | — | — | — | — |
| composi- | | monomer | FA-513M | — | — | — | — | — | — |
| tion | (A1) OH- | (a12) Flexible | FA2D | 20.0 | 20.0 | 20.0 | 20.0 | 20.0 | 20.0 |
| | containing | structure (OH)- | FA5 | 15.0 | 15.0 | 15.0 | 15.0 | 15.0 | 15.0 |
| | (meth)acrylate | containing | HEMAC1 | — | — | — | — | — | — |
| | resin | monomer | AE-200 | — | — | — | — | — | — |
| | | Other OH- | HEMA | 10.0 | 10.0 | 10.0 | 10.0 | 10.0 | 10.0 |
| | | containing | HEA | — | — | — | — | — | — |
| | | monomers | 4HBA | — | — | — | — | — | — |
| | | | MMA | — | — | — | — | — | — |
| | | | BMA | — | — | — | — | — | — |
| | | | BA | 5.0 | 5.0 | 5.0 | 5.0 | 5.0 | 5.0 |
| | | | 2-EHA | — | — | — | — | — | — |
| | | | MAA | — | — | — | — | — | — |
| | | PDMS monomer | FM-0721 | — | — | — | — | — | — |
| | | OH value (KOH mg/g) | | 88.0 | 88.0 | 88.0 | 88.0 | 88.0 | 88.0 |
| | | Glass transition temperature (° C.) | | 8.8 | 8.8 | 8.8 | 8.8 | 8.8 | 8.8 |
| | | Number average molecular weight | | 5.7 | 5.7 | 5.7 | 5.7 | 5.7 | 5.7 |
| | | (×1000) | | | | | | | |
| | | Weight average molecular weight | | 24.0 | 24.0 | 24.0 | 24.0 | 24.0 | 24.0 |
| | | (×1000) | | | | | | | |
| | (A2) | Polycarbonate | T5650E | — | 30.0 | — | — | 100.0 | 300.0 |
| | Polyol | | T5651 | — | — | 30.0 | — | — | — |
| | | | T5652 | — | — | — | 30.0 | — | — |
| | | | G3450J | — | — | — | — | — | — |
| | | | UM-90 | — | — | — | — | — | — |
| | | polyester | P-530 | — | — | — | — | — | — |
| | | Polycaprolactone | PLACCEL | — | — | — | — | — | — |
| | | | 205 | | | | | | |
| | | | PLACCEL | — | — | — | — | — | — |
| | | | 305T | | | | | | |
| | | | PLACCEL | — | — | — | — | — | — |
| | | | 410 | | | | | | |
| | | Polyether | PTMG650 | — | — | — | — | — | — |
| | | OH value | KOH mg/g | — | 224.0 | 112.0 | 56.0 | 224.0 | 224.0 |
| | Total OH value (A1 +A2) | | KOH mg/g | 88.0 | 119.4 | 93.5 | 80.6 | 156.0 | 190.0 |
| | (B) Poly- | Polyfunctional | TKA-100 | 33.3 | 59.0 | 46.2 | 39.7 | 118.5 | 288.5 |
| | functional | isocyanates | 24A-100 | — | — | — | — | — | — |
| | isocyanate | | P301-75E | — | — | — | — | — | — |
| | compound | | D-131N | — | — | — | — | — | — |
| | | NCO % | % | 21.7 | 21.7 | 21.7 | 21.7 | 21.7 | 21.7 |

| | | | | | | |
|---|---|---|---|---|---|---|
| Isocyanate index | 1.1 | 1.1 | 1.1 | 1.1 | 1.1 | 1.1 |

| | Surface conditioner | BYK-302 | — | — | — | — | — | — |
|---|---|---|---|---|---|---|---|---|
| | tanδ Peak top temperature (° C.) | | 62 | 49 | 45 | 42 | 35 | 20 |
| Laminated | Cured layer thickness (μm) | | 10 | 10 | 10 | 10 | 10 | 10 |
| film | Substrate layer | Type | TPU | TPU | TPU | TPU | TPU | TPU |
| | | Thickness (μm) | 150 | 150 | 150 | 150 | 150 | 150 |

| | | | | | | | |
|---|---|---|---|---|---|---|---|
| Evaluation | Processability (elongation at break (%)) | 116 | 126 | 132 | 140 | 144 | 192 |
| | Water scale resistance | 4 | 4 | 4 | 3 | 4 | 3 |
| | Chemical resistance | 4 | 4 | 3 | 3 | 4 | 3 |
| | Coating appearance | Δ | Δ | Δ | Δ | Δ | Δ |
| | Scratch resistance | 3 | 4 | 4 | 4 | 5 | 5 |
| | Resistance to felt pen ink stains | 4 | 3 | 3 | 3 | 3 | 2 |

TABLE 9

| | | | | Examples | | | | | | |
|---|---|---|---|---|---|---|---|---|---|---|
| | | | | 19 | 35 | 36 | 37 | 38 | 23 | 39 |
| Cured | (A1) Synthesis Example | | | A1-4 | A1-4 | A1-4 | A1-4 | A1-14 | A1-14 | A1-14 |
| layer of | | (a11) Alicyclic | CHMA | 50.0 | 50.0 | 50.0 | 50.0 | 25.0 | 25.0 | 25.0 |
| coating | | structure- | IB-X | — | — | — | — | — | — | — |
| agent | | containing | IB-XA | — | — | — | — | 25.0 | 25.0 | 25.0 |
| composi- | | monomer | FA-513M | — | — | — | — | — | — | — |
| tion | (A1) OH- | (a12) Flexible | FA2D | 20.0 | 20.0 | 20.0 | 20.0 | 20.0 | 20.0 | 20.0 |
| | containing | structure (OH)- | FA5 | 15.0 | 15.0 | 15.0 | 15.0 | 10.0 | 10.0 | 10.0 |
| | (meth)acrylate | containing | HEMAC1 | — | — | — | — | — | — | — |
| | resin | monomer | AE-200 | — | — | — | — | — | — | — |
| | | Other OH- | HEMA | 10.0 | 10.0 | 10.0 | 10.0 | 15.0 | 15.0 | 15.0 |
| | | containing | HEA | — | — | — | — | — | — | — |
| | | monomers | 4HBA | — | — | — | — | — | — | — |
| | | | MMA | — | — | — | — | — | — | — |
| | | | BMA | — | — | — | — | — | — | — |
| | | | BA | 5.0 | 5.0 | 5.0 | 5.0 | 5.0 | 5.0 | 5.0 |
| | | | 2-EHA | — | — | — | — | — | — | — |
| | | | MAA | — | — | — | — | — | — | — |
| | | PDMS monomer | FM-0721 | — | — | — | — | — | — | — |
| | | OH value (KOH mg/g) | | 88.0 | 88.0 | 88.0 | 88.0 | 105.5 | 105.5 | 105.5 |
| | | Glass transition temperature (° C.) | | 8.8 | 8.8 | 8.8 | 8.8 | 19.6 | 19.6 | 19.6 |
| | | Number average molecular weight | | 5.7 | 5.7 | 5.7 | 5.7 | 5.6 | 5.6 | 5.6 |
| | | (×1000) | | | | | | | | |
| | | Weight average molecular weight | | 24.0 | 24.0 | 24.0 | 24.0 | 24.0 | 24.0 | 24.0 |
| | | (×1000) | | | | | | | | |
| | (A2) | Polycarbonate | T5650E | 100.0 | 100.0 | 100.0 | 100.0 | — | — | — |
| | Polyol | | G3450J | — | — | — | — | 100.0 | 100.0 | 100.0 |
| | | | UM-90 | — | — | — | — | — | — | — |
| | | polyester | P-530 | — | — | — | — | — | — | — |
| | | Polycaprolactone | PLACCEL | — | — | — | — | — | — | — |
| | | | 205 | | | | | | | |
| | | | PLACCEL | — | — | — | — | — | — | — |
| | | | 305T | | | | | | | |
| | | | PLACCEL | — | — | — | — | — | — | — |
| | | | 410 | | | | | | | |
| | | Polyether | PTMG650 | — | — | — | — | — | — | — |
| | | OH value | KOH mg/g | 224.0 | 224.0 | 224.0 | 224.0 | 140.0 | 140.0 | 140.0 |
| | Total OH value (A1 + A2) | | KOH mg/g | 156.0 | 156.0 | 156.0 | 156.0 | 122.8 | 122.8 | 122.8 |
| | (B) Poly- | Polyfunctional | TKA-100 | 118.5 | — | — | — | 42.4 | 93.3 | 127.3 |
| | functional | isocyanates | 24A-100 | — | 109.6 | — | — | — | — | — |
| | isocyanate | | P301-75E | — | — | 154.0 | — | — | — | — |
| | compound | | D-131N | — | — | — | 137.3 | — | — | — |
| | | NCO % | % | 21.7 | 23.5 | 16.7 | 18.7 | 21.7 | 21.7 | 21.7 |

| | | | | | | | |
|---|---|---|---|---|---|---|---|
| Isocyanate index | 1.1 | 1.1 | 1.1 | 1.1 | 0.5 | 1.1 | 1.5 |

| | Surface conditioner | BYK-302 | — | — | — | — | — | — | — |
|---|---|---|---|---|---|---|---|---|---|
| | tanδ Peak top temperature (° C.) | | 35 | 31 | 34 | 70 | 24 | 40 | 52 |
| Laminated | Cured layer thickness (μm) | | 10 | 10 | 10 | 10 | 10 | 10 | 10 |
| film | Substrate layer | Type | TPU | TPU | TPU | TPU | TPU | TPU | TPU |
| | | Thickness (μm) | 150 | 150 | 150 | 150 | 150 | 150 | 150 |

| | | | | | | | | |
|---|---|---|---|---|---|---|---|---|
| Evaluation | Processability (elongation at break (%)) | 144 | 122 | 126 | 124 | 140 | 116 | 98 |
| | Water scale resistance | 4 | 4 | 4 | 5 | 3 | 4 | 4 |
| | Chemical resistance | 4 | 3 | 4 | 5 | 3 | 4 | 4 |
| | Coating appearance | Δ | Δ | Δ | Δ | Δ | Δ | Δ |
| | Scratch resistance | 5 | 5 | 5 | 3 | 5 | 5 | 4 |
| | Resistance to felt pen ink stains | 3 | 2 | 3 | 4 | 2 | 3 | 3 |

TABLE 10

| | | | | Examples | | |
|---|---|---|---|---|---|---|
| | | | | 40 | 23 | 41 |
| Cured | (A1) Synthesis Example | | | A1-14 | A1-14 | A1-14 |
| layer of | | (a11) Alicyclic | CHMA | 25.0 | 25.0 | 25.0 |
| coating | | structure- | IB-X | — | — | — |
| agent | | containing | IB-XA | 25.0 | 25.0 | 25.0 |
| composi- | | monomer | FA-513M | — | — | — |
| tion | (A1) OH- | (a12) Flexible | FA2D | 20.0 | 20.0 | 20.0 |
| | containing | structure (OH)- | FA5 | 10.0 | 10.0 | 10.0 |
| | (meth)acrylate | containing | HEMAC1 | — | — | — |
| | resin | monomer | AE-200 | — | — | — |
| | | Other OH- | HEMA | 15.0 | 15.0 | 15.0 |
| | | containing | HEA | — | — | — |
| | | monomers | 4HBA | — | — | — |
| | | | MMA | — | — | — |
| | | | BMA | — | — | — |
| | | | BA | 5.0 | 5.0 | 5.0 |
| | | | 2-EHA | — | — | — |
| | | | MAA | — | — | — |
| | | PDMS monomer | FM-0721 | — | — | — |
| | | OH value (KOH mg/g) | | 105.5 | 105.5 | 105.5 |
| | | Glass transition temperature (° C.) | | 19.6 | 19.6 | 19.6 |
| | | Number average molecular weight | | 5.6 | 5.6 | 5.6 |
| | | (×1000) | | | | |
| | | Weight average molecular weight | | 24.0 | 24.0 | 24.0 |
| | | (×1000) | | | | |
| | (A2) | Polycarbonate | T5650E | — | — | — |
| | Polyol | | G3450J | 100.0 | 100.0 | 100.0 |
| | | | UM-90 | — | — | — |
| | | polyester | P-530 | — | — | — |
| | | Polycaprolactone | PLACCEL | — | — | — |
| | | | 205 | | | |
| | | | PLACCEL | — | — | — |
| | | | 305T | | | |
| | | | PLACCEL | — | — | — |
| | | | 410 | | | |
| | | Polyether | PTMG650 | — | — | — |
| | | OH value | KOH mg/g | 140.0 | 140.0 | 140.0 |
| | Total OH value (A1 + A2) | | KOH mg/g | 122.8 | 122.8 | 122.8 |
| | (B) Poly- | Polyfunctional | TKA-100 | 93.3 | 93.3 | 93.3 |
| | functional | isocyanates | 24A-100 | — | — | — |
| | isocyanate | | P301-75E | — | — | — |
| | compound | | D-131N | — | — | — |
| | | NCO % | % | 21.7 | 21.7 | 21.7 |

| | | | |
|---|---|---|---|
| Isocyanate index | 1.1 | 1.1 | 1.1 |

| | Surface conditioner | BYK-302 | — | — | — |
|---|---|---|---|---|---|
| | tanδ Peak top temperature (° C.) | | 42 | 40 | 42 |
| Laminated | Cured layer thickness (μm) | | 3 | 10 | 30 |
| film | Substrate layer | Type | TPU | TPU | TPU |
| | | Thickness (μm) | 150 | 150 | 150 |

| | | | | |
|---|---|---|---|---|
| Evaluation | Processability (elongation at break (%)) | 160 | 116 | 84 |
| | Water scale resistance | 3 | 4 | 4 |
| | Chemical resistance | 3 | 4 | 5 |
| | Coating appearance | Δ | Δ | Δ |
| | Scratch resistance | 5 | 5 | 5 |
| | Resistance to felt pen ink stains | 3 | 3 | 3 |

TABLE 11

| | | | | Comparative Examples | | | | | | | |
|---|---|---|---|---|---|---|---|---|---|---|---|
| | | | | 1 | 2 | 3 | 4 | 5 | 6 | 7 | 8 |
| Cured | (A1) Synthesis Example | | | A1-19 | A1-20 | A1-21 | A1-22 | A1-23 | A1-24 | A1-24 | A1-25 |
| layer of | | (a11) Alicyclic | CHMA | 25.0 | 25.0 | 10.0 | — | — | — | — | 25.0 |
| coating | | structure- | IB-X | 25.0 | 25.0 | 45.0 | | | | | — |
| agent | | containing | IB-XA | — | — | — | | | | | 25.0 |
| composi- | | monomer | FA-513M | — | — | — | | | | | — |
| tion | (A1) OH- | (a12) Flexible | FA2D | 5.0 | 25.0 | — | 20.0 | 20.0 | 20.0 | 20.0 | — |
| | containing | structure (OH)- | FA5 | 5.0 | — | — | 15.0 | 15.0 | 15.0 | 15.0 | |
| | (meth)acrylate | containing | HEMAC1 | — | — | — | — | — | — | — | |
| | resin | monomer | AE-200 | — | — | — | — | — | — | — | |
| | | Other OH- | HEMA | 5.0 | — | 5.0 | 10.0 | 10.0 | 10.0 | 10.0 | — |
| | | containing | HEA | — | 25.0 | — | — | — | — | — | |
| | | monomers | 4HBA | — | — | 20.0 | — | — | — | — | |
| | | | MMA | — | — | — | 50.0 | 50.0 | 50.0 | 50.0 | 25.0 |
| | | | BMA | 10.0 | — | 10.0 | — | 4.0 | 5.0 | 5.0 | — |
| | | | BA | 25.0 | — | — | — | — | — | — | 25.0 |
| | | | 2-EHA | — | — | 10.0 | — | — | — | — | — |
| | | | MAA | — | — | — | 1.0 | 1.0 | — | — | — |
| | | PDMS monomer | FM-0721 | — | — | — | 4.0 | — | — | — | — |
| | | OH value (KOH mg/g) | | 33.8 | 161.7 | 99.5 | 88.0 | 88.0 | 88.0 | 88.0 | 0.0 |
| | | Glass transition temperature (° C.) | | 24.0 | 27.2 | 42.2 | 28.2 | 27.8 | 26.5 | 26.5 | 37.4 |
| | | Number average molecular weight | | 5.8 | 5.6 | 5.8 | 6.5 | 6.0 | 6.2 | 6.2 | 5.6 |
| | | (×1000) | | | | | | | | | |
| | | Weight average molecular weight | | 28.0 | 26.0 | 26.0 | 35.0 | 34.0 | 34.0 | 34.0 | 24.0 |
| | | (×1000) | | | | | | | | | |
| | (A2) | Polycarbonate | T5650E | — | — | — | — | — | — | 100.0 | 100.0 |
| | Polyol | | G3450J | — | — | — | — | — | — | — | — |
| | | | UM-90 | — | — | — | — | — | — | — | — |
| | | polyester | P-530 | — | — | — | — | — | — | — | — |
| | | Polycaprolactone | PLACCEL | — | — | — | — | — | — | — | — |
| | | | 205 | | | | | | | | |
| | | | PLACCEL | — | — | — | — | — | — | — | — |
| | | | 305T | | | | | | | | |
| | | | PLACCEL | — | — | — | — | — | — | — | — |
| | | | 410 | | | | | | | | |
| | | Polyether | PTMG650 | — | — | — | — | — | — | — | — |
| | | OH value | KOH mg/g | — | — | — | — | — | — | 224.0 | 224.0 |
| | Total OH value (A1 + A2) | | KOH mg/g | 33.8 | 161.7 | 99.5 | 88.0 | 88.0 | 88.0 | 156.0 | 112.0 |
| | (B) Poly- | Polyfunctional | TKA-100 | 12.9 | 61.3 | 37.7 | 33.3 | 33.3 | 33.3 | 118.5 | 84.9 |
| | functional | isocyanates | 24A-100 | — | — | — | — | — | — | — | — |
| | isocyanate | | P301-75E | — | — | — | — | — | — | — | — |
| | compound | | D-131N | — | — | — | — | — | — | — | — |
| | | NCO % | % | 21.7 | 21.7 | 21.7 | 21.7 | 21.7 | 21.7 | 21.7 | 21.7 |

| | | | | | | | | |
|---|---|---|---|---|---|---|---|---|
| Isocyanate index | 1.1 | 1.1 | 1.1 | 1.1 | 1.1 | 1.1 | 1.1 | 1.1 |

| | Surface conditioner | BYK-302 | — | — | — | — | — | — | — | — |
|---|---|---|---|---|---|---|---|---|---|---|
| | tanδ Peak top temperature (° C.) | | 50 | 100 | 80 | 75 | 74 | 74 | 36 | 18 |
| Laminated | Cured layer thickness (μm) | | 10 | 10 | 10 | 10 | 10 | 10 | 10 | 10 |
| film | Substrate layer | Type | TPU | TPU | TPU | TPU | TPU | TPU | TPU | TPU |
| | | Thickness (μm) | 150 | 150 | 150 | 150 | 150 | 150 | 150 | 150 |

| | | | | | | | | | |
|---|---|---|---|---|---|---|---|---|---|
| Evaluation | Processability (elongation at break (%)) | 260 | 38 | 50 | 102 | 104 | 106 | 126 | 240 |
| | Water scale resistance | 2 | 5 | 5 | 2 | 2 | 2 | 2 | 3 |
| | Chemical resistance | 2 | 5 | 5 | 2 | 2 | 2 | 1 | 1 |
| | Coating appearance | Δ | Δ | Δ | ◯ | Δ | Δ | Δ | Δ |
| | Scratch resistance | 4 | 1 | 1 | 2 | 2 | 2 | 5 | 5 |
| | Resistance to felt pen ink stains | 3 | 4 | 4 | 4 | 4 | 4 | 2 | 2 |

As is clear from the results in Table 11, when the hydroxyl value of the hydroxyl group-containing (meth)acrylic resin in the coating agent composition was small, the desired water scale resistance and the chemical resistance failed to be obtained in the cured film. (Comparative Example 1). On the other hand, when the hydroxyl value was large, the desired processability failed to be obtained in the cured film (Comparative Example 2), and even though the hydroxyl value was adjusted by using a normal hydroxyl group-containing monomer such as HEMA as a constituent monomer of the hydroxyl group-containing (meth)acrylic resin, the desired processability failed to be obtained in the cured film (Comparative Example 3). When the total hydroxyl value was adjusted by blending a polyol in a coating agent composition, then the desired chemical resistance failed to be obtained in the cured film (Comparative Example 8). Furthermore, also when no monomer having an alicyclic structure was used as a constituent monomer of the hydroxyl group-containing (meth)acrylic resin but the hydroxyl value was adjusted by using a little much monomer having a flexible structure, the desired water scale resistance and the desired chemical resistance failed to be obtained in the cured films (Comparative Examples 4 to 7).

On the other hand, as is clear from the results of Tables 4 to 10, cured layers superior in water scale resistance and chemical resistance as well as processability were obtained by designing the hydroxyl value of the (meth)acrylic resin the coating agent composition to fall within the range of 50 to 150 mg KOH/g, thereby introducing a specific flexible structure, and also introducing an alicyclic structure (Examples 1 to 37). Therefore, it has been shown that a laminated film having such a cured layer that exhibits superior water scale resistance and chemical resistance as well as processability is useful as a laminated film for protecting an exterior curved surface of a vehicle.

### Test Example 2

For the coating agent composition of Example 19, Comparative Example 6 and Comparative Example 7 prepared in Test Example 1, the following accelerated weatherability test was conducted as a weatherability test under artificial conditions that have been used for the weatherability evaluation of PPF. The results are shown in Table 12.

A sample for an accelerated weatherability test was prepared by attaching a laminated film in which a 10 μm thick cured layer of the coating agent composition was laminated on a thermoplastic polyurethane substrate layer through a 50 μm thick applied layer of a silicon acrylic resin paint (ALCO SP White/ALCO SP No. 2 curing agent manufactured by Natoco Co., Ltd.) onto an aluminum sheet (1 mm thick×70 mm×180 mm). The sample was placed such that the cured film faced the light irradiation side, and the accelerated weatherability test was conducted under the following conditions in accordance with JIS K 5600 7-7 (accelerated weatherability test, xenon method).

(Weatherability Conditions)
Testing machine: Super Xenon Weather Meter SX75
Filter: inner/outer=quartz/#275 (borosilicate glass)
Cycle: continuous operation
Drying time: 102 minutes (63° C., 50% humidity)
Wetting time: 18 minutes (28° C., humidity: 95%)
Irradiation intensity: 60 W/m²
Exposure time: 960 hours

(Weatherability Evaluation—Gloss Retention Ratio)

The 60° gloss value of each of the sample cured films before and after the accelerated test was measured by using a gloss meter (manufactured by BYK-Gardner GmbH, trade name: Micro-Gloss), and then the gloss retention ratio (%) was calculated.

(Weatherability Evaluation—Color Difference)

The L*, a* and b* of each of the sample cured films before and after the accelerated test were measured by using a color difference meter (manufactured by Konica Minolta, Inc., trade name: CR-200), and then ΔE* was calculated by the following formula.

ΔL*=L* before accelerated test−L* after accelerated test

Δa*=a* before accelerated test−a* after accelerated test

Δb*=b* before accelerated test−b* after accelerated test

ΔE*=√(ΔL*²+Δa*²+Δb*²)

TABLE 12

| | | | | Examples | Comparative Examples | |
|---|---|---|---|---|---|---|
| | | | | 19 | 6 | 7 |
| Cured | (A1) Synthesis Example | | | A1-4 | A1-24 | A1-24 |
| layer of | | (a11) Alicyclic | CHMA | 50.0 | — | — |
| coating | | structure- | IB-X | — | | |
| agent | | containing | IB-XA | — | | |
| composi- | | monomer | FA-513M | — | | |
| tion | (A1) OH- | (a12) Flexible | FA2 | 20.0 | 20.0 | 20.0 |
| | containing | structure (OH)- | FA5 | 15.0 | 15.0 | 15.0 |
| | (meth)acrylate | containing | HEMAC1 | — | — | — |
| | resin | monomer | AE-200 | — | — | — |
| | | Other OH- | HEMA | 10.0 | 10.0 | 10.0 |
| | | containing | HEA | — | — | — |
| | | monomers | 4-HBA | — | — | — |
| | | | MMA | — | 50.0 | 50.0 |
| | | | BMA | — | 5.0 | 5.0 |
| | | | BA | 5.0 | — | — |
| | | | 2-EHA | — | — | — |
| | | | MAA | — | — | — |
| | | PDMS monomer | FM-0721 | — | — | — |
| | | OH value (KOH mg/g) | | 88.0 | 88.0 | 88.0 |
| | | Glass transition temperature (° C.) | | 8.8 | 26.5 | 26.5 |
| | | Number average molecular weight | | 5.7 | 6.2 | 6.2 |
| | | (×1000) | | | | |
| | | Weight average molecular weight | | 24.0 | 34.0 | 34.0 |
| | | (×1000) | | | | |
| | (A2) | Polycarbonate | T5650E | 100.0 | — | 100.0 |
| | Polyol | | G3450J | — | — | — |
| | | | UM-90 | — | — | — |
| | | polyester | P-530 | — | — | — |
| | | Polycaprolactone | PLACCEL | — | — | — |
| | | | 205 | | | |
| | | | PLACCEL | — | — | — |
| | | | 305 | | | |
| | | | PLACCEL | — | — | — |
| | | | 410 | | | |
| | | Polyether | PTMG650 | — | — | — |
| | | OH value | KOH mg/g | 224.0 | — | 224.0 |
| | Total OH value (A1 + A2) | | KOH mg/g | 156.0 | 88.0 | 156.0 |
| | (B) Poly- | Polyfunctional | TKA-100 | 118.5 | 33.3 | 118.5 |
| | functional | isocyanate | 24A-100 | — | — | — |
| | isocyanate | | P301-75E | — | — | — |
| | compound | | D-131N | — | — | — |
| | | NCO % | % | 21.7 | 21.7 | 21.7 |

| | | | |
|---|---|---|---|
| Isocyanate index | 1.1 | 1.1 | 1.1 |

| | Leveling agent | BYK-302 | — | — | — |
|---|---|---|---|---|---|
| | tanδ Peak top temperature (° C.) | | 35 | 74 | 36 |
| | Cured film thickness (μm) | | 10 | 10 | 10 |
| Evaluation | Accelerated weatherability test | Initial gloss value | 93.9 | 91.8 | 91.3 |
| | | Post-acceleration | 93.0 | 92.3 | 92.1 |
| | | gloss value | | | |
| | | Gloss retention | 101.0 | 99.5 | 99.1 |
| | | ratio (%) | | | |
| | | Color difference | 1.0 | 1.6 | 1.1 |
| | | ΔE | | | |

As is clear from Table 12, in the usual accelerated weatherability test, the weatherability of Example 19 was slightly higher than those of Comparative Examples 6 and 7, but no noticeable difference was observed. In particular, almost no difference was observed in gloss retention ratio. That is, the water scale-like stain confirmed in the comparative examples of Test Example 1 is a phenomenon that does not occur under the conditions of a usual accelerated weatherability test and occurs peculiarly to practical use conditions of a laminated film, which are various of anomalous factors of nature, and the water scale resistance confirmed in the examples of Test Example 1 can be said to be an excellent effect that can prevents the occurrence of such a peculiar phenomenon.

1. A coating agent composition for a laminated film to protect an exterior curved surface of a vehicle, comprising
a component (A1): a (meth)acrylic resin having a hydroxyl group, and
a component (B): a polyfunctional isocyanate compound,
wherein the component (A1) has an alicyclic structure (a11) and a structure (a12) selected from the group consisting of polylactone, polycarbonate, polyester and polyether, and
the component (A1) has a hydroxyl value of 50 to 150 mg KOH/g.

2. The coating agent composition according to claim 1, wherein an amount of a constitutional unit having the structure (a11) is 25 to 70 parts by mass per 100 parts by mass of the component (A1).

3. The coating agent composition according to claim 1, wherein an amount of a constitutional unit having the structure (a12) is 10 to 60 parts by mass per 100 parts by mass of the component (A1).

4. The coating agent composition according to claim 1, wherein an equivalent ratio of the number of isocyanate groups of the component (B) to the number of hydroxyl groups of the component (A1) is 0.5 to 1.5.

5. The coating agent composition according to claim 1, further comprising
a component (A2): a polyol.

6. The coating agent composition according to claim 5, wherein a total hydroxyl value of the components (A1) and (A2) is 50 to 350 mg KOH/g.

7. The coating agent composition according to claim 5, wherein an equivalent ratio of the number of isocyanate groups of the component (B) to the total number of hydroxyl groups of the components (A1) and (A2) is 0.5 to 1.5.

8. A laminated film to protect an exterior curved surface of a vehicle, comprising a substrate layer having an elongation at break of 100% or more and a cured layer of the coating agent composition according to claim 1 laminated on the substrate layer.

9. A vehicle comprising an exterior curved surface to which the laminated film according to claim 8 is attached.
